(19) United States
(12) Patent Application Publication
(10) Pub. No.: US 2026/0352888 A1
(43) Pub. Date: Nov. 5, 2026

(54) PROCESSING ORDER CONTROL OF SUPPLEMENTAL ENHANCEMENT INFORMATION MESSAGES

(71) Applicant: QUALCOMM Incorporated, San Diego, CA (US)

(72) Inventors: Yong He, San Diego, CA (US); Louis Joseph Kerofsky, San Diego, CA (US); Shuai Zhao, Rancho Cordova, CA (US)

(21) Appl. No.: 19/638,409

(22) Filed: Apr. 3, 2026

Related U.S. Application Data
(60) Provisional application No. 63/800,110, filed on May 5, 2025.
(60) Provisional application No. 63/821,284, filed on Jun. 10, 2025.

(51) Int. Cl. H04N 19/70

(52) U.S. Cl. CPC H04N 19/70

(57) ABSTRACT

A video coding device processes supplemental enhancement information (SEI) messages related to video data. The SEI messages include a first SEI message with first syntax elements comprising a first processing order (PO) SEI wrapping flag and a first PO SEI prefix flag, wherein the first syntax elements are indexed by a first index variable. The SEI messages further include a second SEI message with second syntax elements comprising a second PO SEI wrapping flag and a second PO SEI prefix flag, wherein the second syntax elements are indexed by a second index variable distinct from the first index variable. The video coding device determines to apply a constraint on a presence of the second SEI message in an SEI processing order (SPO) SEI message based on the first syntax elements and the second syntax elements. The video coding device codes the second SEI message based on the constraint.

This application claims the benefit of U.S. Provisional Application No. 63/821,284, filed Jun. 10, 2025, and U.S. Provisional Application No. 63/800,110, filed May 5, 2025, the entire contents of each of which are hereby incorporated by reference.

### TECHNICAL FIELD

This disclosure relates to video coding, including video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for signaling and parsing multiple supplemental enhancement information (SEI) messages for a bitstream including video data. SEI messages may be nested in, e.g., processing order nesting (PON) SEI messages, and/or may be described by data of SEI processing order (SPO) SEI messages. An SPO SEI message may include information indicating a preferred processing order, e.g., as determined by an encoding device for a group of types of SEI messages that may be present in a coded layer video sequence (CLVS). A PON SEI message may include one or more SEI messages that are to be applied as parts of the processing chain identified by an associated SEI processing order SEI message. In some examples, the SEI messaging scheme may involve redundant information and/or processing dependencies between PON-nested SEI messages and non-PON-nested SEI messages. This disclosure describes techniques by which SEI messages may be provided in a video bitstream with information that can be used to control processing order of SEI messages in a manner that accounts for such aspects of SEI messages. The techniques of this disclosure may therefore improve processing efficiencies associated with processing SEI messages.

In some examples, a video coding device (e.g., a video encoder and/or video decoder) may process a plurality of SEI messages related to video data. For example, the video coding device may generate or receive a first SEI message and a second SEI message. The first SEI message may include first syntax elements comprising a first processing order (PO) wrapping flag and a first PO prefix flag indexed by a first index variable (e.g., an index variable i). Similarly, the second SEI message may include second syntax elements comprising a second PO wrapping flag and a second PO prefix flag indexed by a distinct second index variable (e.g., an index variable j).

The video coding device may determine to apply a constraint on a presence of the second SEI message within an SPO SEI message based on the first syntax elements and the second syntax elements. For example, the video coding device may compare values of the respective PO wrapping flags and PO prefix flags. By using distinct index variables, this comparison includes values that would otherwise be missed if the comparison only considered one index variable to compare the first syntax elements of the first SEI message to the second syntax elements of the second SEI message, such as scenarios in which the first index variable does not equal the second index variable, i.e., scenarios in which i≠j.

The video coding device may encode or decode the second SEI message, in accordance with the applied constraint. Applying the constraint prevents invalid message combinations, such as preventing the SEI information message from being present in the SPO SEI message when specific flag conditions are met. By enforcing structural rules for message presence, the techniques streamline SEI message processing, reduce decoding errors, and ensure accurate video data reproduction across various CLVSs.

In an example, this disclosure describes an apparatus configured to decode video data, the apparatus comprising at least one memory, and processing circuitry in communication with the at least one memory, the processing circuitry configured to receive a first SEI message related to the video data, wherein the first SEI message includes first syntax elements comprising a first PO SEI wrapping flag and a first PO SEI prefix flag, wherein the first syntax elements are indexed by a first index variable, receive a second SEI message related to the video data, wherein the second SEI message includes second syntax elements comprising a second PO SEI wrapping flag and a second PO SEI prefix flag, wherein the second syntax elements are indexed by a second index variable distinct from the first index variable, determine to apply a constraint on a presence of the second SEI message in an SPO SEI message based on the first syntax elements and the second syntax elements, and decode the second SEI message based on the constraint.

In another example, this disclosure describes a method for decoding video data, the method comprising receiving, by processing circuitry, a first SEI message related to the video data, wherein the first SEI message includes first syntax elements comprising a first PO SEI wrapping flag and a first PO SEI prefix flag, wherein the first syntax elements are indexed by a first index variable, receiving, by the processing circuitry, a second SEI message related to the video data, wherein the second SEI message includes second syntax elements comprising a second PO SEI wrapping flag and a second PO SEI prefix flag, wherein the second syntax elements are indexed by a second index variable distinct from the first index variable, determining, by the processing circuitry, to apply a constraint on a presence of the second SEI message in an SPO SEI message based on the first syntax elements and the second syntax elements, and decoding, by the processing circuitry, the second SEI message based on the constraint.

In another example, this disclosure describes an apparatus configured to encode video data, the apparatus comprising at least one memory, and processing circuitry in communication with the at least one memory, the processing circuitry configured to generate a first SEI message related to the video data, wherein the first SEI message includes first syntax elements comprising a first PO SEI wrapping flag and a first PO SEI prefix flag, wherein the first syntax elements are indexed by a first index variable, generate a second SEI message related to the video data, wherein the second SEI message includes second syntax elements comprising a second PO SEI wrapping flag and a second PO SEI prefix flag, wherein the second syntax elements are indexed by a second index variable distinct from the first index variable, determine to apply a constraint on a presence of the second SEI message in an SPO SEI message based on the first syntax elements and the second syntax elements, and encode the second SEI message based on the constraint.

The details of one or more examples are set forth in the accompanying drawings and the description below. Other features, objects, and advantages will be apparent from the description, drawings, and claims.

### BRIEF DESCRIPTION OF THE DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a flowchart illustrating an example method for encoding a current block, in accordance with the techniques of this disclosure.

FIG. 5 is a flowchart illustrating an example method for decoding a current block, in accordance with the techniques of this disclosure.

FIG. 6 is a flowchart illustrating an example method for encoding supplemental enhancement information (SEI) messages related to video data, in accordance with the techniques of this disclosure.

FIG. 7 is a flowchart illustrating an example method for decoding SEI messages related to video data, in accordance with the techniques of this disclosure.

### DETAILED DESCRIPTION

Coding (encoding and decoding) of video data generally involves partitioning a picture of an image sequence into individual blocks, forming a prediction block for each block, and coding a residual block representing sample-by-sample differences between an original block and the prediction block. Prediction may be intra-frame (that is, within the frame including the current block being coded) or inter-frame (that is, from a different frame than the frame including the current block being coded).

Coded video data may be organized into Network Abstraction Layer (NAL) units, which provide a “network-friendly” video representation addressing applications such as video telephony, storage, broadcast, or streaming. NAL units can be categorized as Video Coding Layer (VCL) NAL units and non-VCL NAL units. VCL units may contain data for the core compression engine and may include block and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and supplemental enhancement information (SEI) NAL units, among others. Parameter sets may contain sequence-level header information (in sequence parameter sets (SPS)) and infrequently changing picture-level header information (in picture parameter sets (PPS)). With parameter sets (e.g., PPS and SPS), infrequently changing information need not be repeated for each sequence or picture; hence, coding efficiency may be improved. Furthermore, the use of parameter sets may enable out-of-band transmission of the relevant header information, avoiding the need for redundant transmissions for error resilience. In out-of-band transmission examples, parameter set NAL units may be transmitted on a different channel than other NAL units, such as SEI NAL units.

Supplemental Enhancement Information (SEI) messages may contain information that is not necessary for decoding coded pictures of VCL NAL units, but may assist in processes related to decoding, display, error resilience, and other purposes. SEI messages may be contained in non-VCL NAL units. SEI messages are the normative part of some standard specifications, and thus, are not always mandatory for a standards-compliant decoder implementation. SEI messages may be sequence level SEI messages or picture level SEI messages. Some sequence level information may be contained in SEI messages, such as scalability information SEI messages in the example of scalable video coding (SVC) and view scalability information SEI messages in multi-view video coding (MVC). These example SEI messages may convey information on, e.g., extraction of operation points and characteristics of the operation points.

A standard may specify video usability information (VUI) and SEI messages used within a video bitstream. Versatile Supplemental Enhancement Information (VSEI), per ITU-T H.274 and ISO/IEC 23002-7, is an example of such a standard. The SEI mechanism enables encoders to include metadata in the bitstream that is not required for the correct decoding of sample values of output pictures, but can be used for various other purposes. Encoders can include any number of SEI NAL units in an access unit, and each SEI NAL unit may contain one or more SEI messages. Specifications and systems using VVC may require encoders to generate certain SEI messages or may define specific handling of particular types of received SEI messages.

An SPO SEI message carries information indicating the preferred processing order, as determined by the encoder (i.e., the content producer), for a group of types of SEI messages that may be present in a CLVS. A PON SEI message includes one or more SEI messages that are configured to be applied as parts of the processing chain identified by an associated SEI processing order SEI message. A text description information (TDI) SEI message provides text description about one or more pictures. All of these SEI messages are specified in VSEI version 4 (Draft 6), which was finalized at the 38th Joint Video Experts Team (JVET) meeting.

In the 38^{th} JVET meeting, the complexity information of mandatory stage, renamed “root processes,” was agreed to be added in SPO SEI message extensions. The i-th SEI message of a processing chain may be identified as a root process when a decoding device should not apply the entire processing chain if the decoding device cannot interpret or does not support the i-th SEI message type, where i is an integer value. However, the decoding device may not have complexity information about root processes in a processing chain. This disclosure describes techniques by which SEI messages may be provided in a video bitstream with information to indicate the complexity information of root processes and to indicate whether the complexity information for all elements in a processing chain is identical. Consequently, when the elements in a processing chain have identical complexity information, the complexity information of a root process may be derived from the processing chain complexity information specified in an SPO SEI message. Accordingly, a decoding device may determine whether or not to apply the processing chain based on the complexity information. For example, the decoding device may not apply the processing chain if the complexity information is such that the decoding device cannot interpret or does not support a root process of the processing chain.

By inferring the complexity information of the root processes directly from the processing chain complexity information when the identical complexity flag is set, a video encoder may avoid explicitly transmitting redundant complexity parameters for the individual root processes. This reduces signaling overhead and conserves bandwidth within an encoded video bitstream, while still providing a video decoder with the necessary metrics to efficiently determine whether the processing chain can be supported by the video decoder.

The SEI messaging scheme may involve other types of redundant information and/or processing dependencies between PON-nested SEI messages and non-PON-nested SEI messages. This disclosure also describes techniques by which SEI messages may be provided in a video bitstream with information that can be used to control processing order of SEI messages in a manner that accounts for such aspects of SEI messages. The techniques of this disclosure may therefore improve processing efficiencies associated with processing SEI messages.

In some examples, a video coding device (e.g., a video encoder and/or video decoder) may process a plurality of SEI messages related to video data. For example, the video coding device may generate or receive a first SEI message and a second SEI message. The first SEI message may include first syntax elements comprising a first processing order (PO) wrapping flag and a first PO prefix flag indexed by a first index variable (e.g., an index variable i). Similarly, the second SEI message may include second syntax elements comprising a second PO wrapping flag and a second PO prefix flag indexed by a distinct second index variable (e.g., an index variable j).

The video coding device may determine to apply a constraint on a presence of the second SEI message within an SPO SEI message based on the first syntax elements and the second syntax elements. For example, the video coding device may determine whether to apply the constraint by comparing values of the respective PO wrapping flags and PO prefix flags. A prefix differentiates SEI messages sharing a same payload type. In some examples, the constraint applied by the video coding device is a PO SEI prefix flag constraint that prevents a co-existence of one SEI message having a prefix and another SEI message having the same payload type but lacking a prefix.

Some techniques for applying PO SEI prefix flag constraints utilize a single index variable to compare the first syntax elements of the first SEI message to the second syntax elements of the second SEI message. However, if a single index variable is used to evaluate syntax elements corresponding to the first and second SEI messages, the comparison may not consider values that should be subject to the constraint. By using distinct index variables, the techniques of this disclosure may apply the constraint to values that would otherwise be missed if the comparison only considered one index variable to compare the first syntax elements of the first SEI message to the second syntax elements of the second SEI message, such as scenarios in which the first index variable does not equal the second index variable, i.e., scenarios in which i #j.

The video coding device may encode or decode the second SEI message, in accordance with the applied constraint. Applying the constraint prevents invalid message combinations, such as preventing the SEI information message from being present in the SPO SEI message when specific flag conditions are met. By enforcing structural rules for message presence, the techniques streamline SEI message processing, reduce decoding errors, and ensure accurate video data reproduction across various CLVSs.

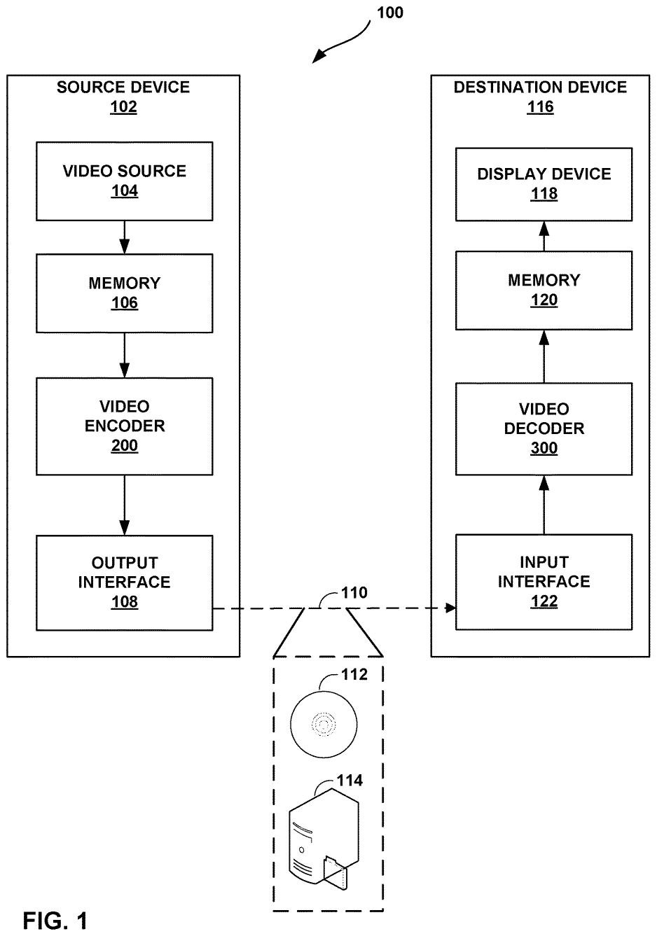

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for processing SEI messages, e.g., according to an SPO. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for processing SEI messages, e.g., according to an SPO. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G Long-Term Evolution (LTE), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. Example audio codecs include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Audio.

Video encoder 200 and video decoder 300 each may be implemented as any of a variety of suitable encoder and/or decoder circuitry of a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may include an integrated circuit, a microprocessor, and/or a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that include processing SEI messages, e.g., according to an SPO.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component may be an array or single sample from one of the three arrays (luma and two chroma) for a picture in 4:2:0, 4:2:2, or 4:4:4 color format, or an array or a single sample of the array for a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may have N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra-prediction (e.g., intra frame prediction or spatial prediction) and inter-prediction (e.g., inter frame prediction or temporal prediction). In the context of AV1, when predicting blocks of a current frame of video data using an intra-prediction mode, video encoder 200 and video decoder 300 do not use video data from other frames of video data. For most intra-prediction modes, video encoder 200 encodes blocks of a current frame based on the difference between sample values in the current block and predicted values generated from reference samples in the same frame. Video encoder 200 determines predicted values generated from the reference samples based on the intra-prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

Furthermore, video encoder 200 may generate SEI messages including metadata that may not be required for the correct decoding of the sample values of the output pictures but that can be used for various other purposes by video decoder 300.

Per the techniques of this disclosure, complexity information of mandatory stage, renamed to root processes, may be added to the SPO SEI message extension. The i-th SEI message may be identified as a root-process when the decoding system should not apply the processing chain if it cannot interpret or does not support the i-th SEI message type. In the examples below, i and j are integer values.

Techniques of the disclosure include signaling various syntax elements to describe processing order and complexity information for supplemental enhancement information messages. Some of the syntax elements are described below.

The syntax element po_root_complexity_info_present_flag indicates whether complexity information for root processes is present.

The syntax element po_same_complexity_info_flag indicates whether complexity information for root processes is identical to complexity information for an entire processing chain.

The syntax element po_root_parameter_type_idc indicates a parameter type used to indicate complexity of invoking neural network post-filters for root processes.

The syntax element po_root_log 2_parameter_bit_length_minus3 indicates a bit length of complexity parameters for root processes.

The syntax element po_root_num_parameters_idc indicates a number of parameters used to indicate complexity of invoking neural network post-filters for root processes.

The syntax element po_root_num_kmac_operations_idc indicates a number of multiply-accumulate operations utilized to invoke neural network post-filters for root processes.

The syntax element po_root_total_kilobyte_size indicates a total size in kilobytes of parameters for neural network post-filters for root processes.

The syntax element po_parameter_type_idc indicates a parameter type used to indicate complexity of invoking neural network post-filters for a processing chain.

The syntax element po_log 2_parameter_bit_length_minus3 indicates a bit length of complexity parameters for a processing chain.

The syntax element po_num_parameters_idc indicates a number of parameters used to indicate complexity of invoking neural network post-filters for a processing chain.

The syntax element po_num_kmac_operations_idc indicates a number of multiply-accumulate operations utilized to invoke neural network post-filters for a processing chain.

The syntax element po_total_kilobyte_size indicates a total size in kilobytes of parameters for neural network post-filters for a processing chain.

The syntax element po_complexity_info_present_flag indicates whether complexity information for a processing chain is present.

The syntax element po_sei_wrapping_flag indicates whether an SEI message is a wrapping SEI message.

The syntax element po_sei_prefix_flag indicates whether an SEI message includes a prefix.

The syntax element po_sei_payload_type indicates a payload type of an SEI message.

The syntax element pon_target_po_id indicates an identifier of a target processing order for a processing order nesting SEI message.

The syntax element pon_num_po_ids_minus1 indicates a number of processing order identifiers associated with a processing order nesting SEI message.

The syntax element pon_processing_order indicates a processing order of a processing order nesting-nested SEI message.

The syntax element pon_num_seis_minus1 indicates a number of processing order nesting-nested SEI messages.

The syntax element po_sei_prefix_data_bit indicates a prefix data bit for an SEI message.

The syntax element po_num_bits_prefix_indication_minus1 indicates a number of bits used for a prefix indication.

The syntax element nnpfc_id indicates an identifier for neural-network post-filter characteristics.

The syntax element fg_characteristics_persistence_flag indicates a persistence of a film grain characteristics SEI message.

The syntax element fg_characteristics_cancel_flag indicates whether to cancel a previous film grain characteristics SEI message.

The syntax element ccv_persistence_flag indicates a persistence of a content color volume SEI message.

The syntax element ccv_cancel_flag indicates whether to cancel a previous content color volume SEI message.

The syntax element erp_persistence_flag indicates a persistence of an equirectangular projection SEI message.

The syntax element erp_cancel_flag indicates whether to cancel a previous equirectangular projection SEI message.

The syntax element gcmp_persistence_flag indicates a persistence of a generalized cubemap projection SEI message.

The syntax element gcmp_cancel_flag indicates whether to cancel a previous generalized cubemap projection SEI message.

The syntax element rwp_persistence_flag indicates a persistence of a region-wise packing SEI message.

The syntax element rwp_cancel_flag indicates whether to cancel a previous region-wise packing SEI message.

The syntax element sari_persistence_flag indicates a persistence of a sample aspect ratio SEI message.

The syntax element sari_cancel_flag indicates whether to cancel a previous sample aspect ratio SEI message.

The syntax element ar_cancel_flag indicates whether to cancel a previous annotated regions SEI message.

The syntax element alpha_channel_cancel_flag indicates whether to cancel a previous alpha channel information SEI message.

The syntax element display_orientation_persistence_flag indicates a persistence of a display orientation SEI message.

The syntax element display_orientation_cancel_flag indicates whether to cancel a previous display orientation SEI message.

The syntax element omi_persistence_flag indicates a persistence of an object mask information SEI message.

The syntax element omi_cancel_flag indicates whether to cancel a previous object mask information SEI message.

The syntax element mi_modality_info_persistence_flag indicates a persistence of a modality information SEI message.

The syntax element mi_modality_info_cancel_flag indicates whether to cancel a previous modality information SEI message.

The syntax element aur_persistence_flag indicates a persistence of an artificial intelligence (AI) usage restriction information SEI message.

The syntax element aur_cancel_flag indicates whether to cancel a previous AI usage restriction information SEI message.

The syntax element spo_vsei_version indicates a largest VSEI version number of the SEI messages indicated by the processing order SEI message.

The syntax element spo_num_vsei_version_minus1 indicates a number of VSEI versions associated with the SEI messages indicated in the processing order SEI message.

The syntax element tdi_descr_purpose indicates a purpose of a text description information SEI message.

The syntax element tdi_descr_string indicates a description of a Versatile SEI specification associated with the SEI messages in a persistence scope of an SEI message.

In some examples, a syntax element is added to indicate the complexity information of the root processes and the complexity information of entire processing chain are identical. As a result, the complexity information of the root processes can be derived from the processing chain complexity information specified in the SPO. An example of the syntax structure is as follows:

| | |
|---|---|
| if( more_data_in_payload( ) && payload_extension_present( )) { | |
| SeiExtensionBitsPresentFlag = 1 | |
| po_root_complexity_info_present_flag | u(1) |
| if( po_root_complexity_info_present_flag ) { | |
| po_same_complexity_info_flag <added text> | u(1) |
| if(!po_same_complexity_info_flag) { <added text> | |
| po_root_parameter_type_idc | u(2) |
| if( po_root_parameter_type_idc != 2 ) | |
| po_root_log2_parameter_bit_length_minus3 | u(2) |
| po_root_num_parameters_idc | u(6) |
| po_root_num_kmac_operations_idc | ue(v) |
| po_root_total_kilobyte_size | ue(v) |
| } | |
| } | |
| } | |

In the example above and in some other examples that are described within this disclosure, additions to VSEI version 4 (Draft 6) are identified as “<added text>.”

In some examples, video encoder 200 and video decoder 300 may be configured to process SEI messages in accordance with semantics in which po_same_complexity_info_flag equal to 0 indicates the syntax elements indicate the complexity of invoking neural network post-filters (NNPFs) in the root processes, po_root_parameter_type_idc, po_root_num_parameters_idc, po_root_num_kmac_operations_idc, po_root_total_kilobyte_size are present.

In some examples, video encoder 200 and video decoder 300 may be configured to process SEI messages in accordance with semantics in which po_same_complexity_info_flag equal to 1 indicates that those syntax elements are not present. When po_same_complexity_info_flag equal to 1 and po_root_parameter_type_idc, po_root_num_parameters_idc, po_root_num_kmac_operations_idc, po_root_total_kilobyte_size are not present, the values of these syntax elements can be inferred to be equal to the value of po_parameter_type_idc, po_log 2_parameter_bit_length_minus3, po_num_parameters_idc, po_num_kmac_operations_idc and po_total_kilobyte_size, respectively. In some examples, when po_same_complexity_info_flag is equal to 1 and po_root_log 2_parameter_bit_length_minus3 is not present, the value of po_root_log 2_parameter_bit_length_minus3 can be inferred to be equal to the value of po_log 2_parameter_bit_length_minus3.

In some examples, to maintain bitstream conformance, video encoder 200 and video decoder 300 may be configured to process SEI messages in accordance with semantics in which po_same_complexity_info_flag is not equal to 1 when po_complexity_info_present_flag is equal to 0.

Since the prefix may provide differentiation between SEI messages of the same payload type, co-existence of one SEI message with a prefix and another SEI message with the same payload type but without prefix is not allowed. VSEI version 4 (Draft 6) includes the following constraint on po_sei_wrapping_flag and po_sei_prefix_flag.

When the i-th SEI message seiA in any SPO SEI message has po_sei_wrapping_flag[i] and po_sei_prefix_flag[i] both equal to 0, there are no other SEI message seiB included in the same SPO SEI message or in a different SPO SEI message in the current CLVS for which all of the following are true:
the value of po_sei_payload_type[i] of seiB is the same as that for seiA;
the value of po_sei_wrapping_flag[i] of seiB is equal to 0; and
the value of po_sei_prefix_flag[i] of seiB is equal to 1.

Because the same variable i is used in the above constraint, the constraint implies that seiA and seiB share the same index i in the same SPO SEI message or in different SPO SEI messages. Such a constraint limitation may cause video encoder 200 and/or video decoder 300 to miss invalid message combinations when the SEI messages have different indexes. Techniques of the disclosure include applying the constraint using distinct index variables, as described below.

When the i-th SEI message seiA in any SPO SEI message has po_sei_wrapping_flag[i] and po_sei_prefix_flag[i] both equal to 0, there are no other SEI message seiB included in the same SPO SEI message or in a different SPO SEI message in the current CLVS for which all of the following are true:
the value of po_sei_payload_type[j] of seiB is the same as that for seiA;
the value of po_sei_wrapping_flag[j] of seiB is equal to 0; and
the value of po_sei_prefix_flag[j] of seiB is equal to 1.

Using distinct index variables i and j may enable application of the constraint across different indexes. Video encoder 200 and video decoder 300 may be configured to process SEI messages, according to the constraint above, with distinct index variables for different SEI messages as explained in the following examples.

In an example, video encoder 200 may be configured to generate a plurality of SEI messages related to video data, wherein the plurality of SEI messages includes at least a first SEI message and a second SEI message. The first SEI message may include first syntax elements comprising a first PO SEI wrapping flag (e.g., po_sei_wrapping_flag[i]) and a first PO SEI prefix flag (e.g., po_sei_prefix_flag[i]). The first syntax elements (e.g., po_sei_wrapping_flag[i], po_sei_prefix_flag[i], etc.) may be indexed by a first index variable (e.g., index variable i). The second SEI message may include second syntax elements comprising a second PO SEI wrapping flag (e.g., po_sei_wrapping_flag[j]) and a second PO SEI prefix flag (e.g., po_sei_prefix_flag[j]). The second syntax elements (e.g., po_sei_wrapping_flag[j], po_sei_prefix_flag[j], etc.) may be indexed by a second index variable (e.g., index variable j) distinct from the first index variable.

Video encoder 200 may be configured to determine to apply a constraint on a presence of the second SEI message in an SPO SEI message based on the first syntax elements (e.g., po_sei_wrapping_flag[i], po_sei_prefix_flag[i], etc.) and the second syntax elements (e.g., po_sei_wrapping_flag[j], po_sei_prefix_flag[j], etc.). Determining to apply the constraint may include using at least one set of index values including a first value for the first index variable (e.g., index variable i) and a second value for the second index variable (e.g., index variable j), where the first value is different from the second value. In other words, the value of index variable i may equal the value of index variable j for some comparisons, and the value of index variable i may be different from the value of index variable j for some comparisons. In this manner, video encoder 200 can determine whether the constraint applies in situations where i≠j, rather than being limited to applying the constraint only in situations where i=j.

In some examples, video encoder 200 may determine that the first PO SEI wrapping flag (e.g., po_sei_wrapping_flag[i]) and the first PO SEI prefix flag (e.g., po_sei_prefix_flag[i]) are equal to zero and further determine to apply the constraint on the presence of the second SEI message in the SPO SEI message based on these determined values. In some examples, video encoder 200 may be configured to determine to apply the constraint when the following conditions are also met: (i) a first PO SEI payload type flag (e.g., po_sei_payload_type[i]) of the first SEI message is equal to a second PO SEI payload type flag (e.g., po_sei_payload_type[j]) of the second SEI message; (ii) the second PO SEI wrapping flag (e.g., po_sei_wrapping_flag[j]) is equal to zero; and the second PO SEI prefix flag (e.g., po_sei_prefix_flag[j]) is equal to one.

Applying the constraint may prevent the second SEI message from being present in the SPO SEI message. In some examples, the SPO SEI message may include the first SEI message. In other examples, the SPO SEI message may be in a same CLVS as a different SPO SEI message that includes the first SEI message.

Video encoder 200 may be configured to encode the second SEI message based on the constraint. For example, video encoder 200 may be configured to generate a non-Video Coding Layer (non-VCL) Network Abstraction Layer (NAL) unit. Video encoder 200 may be configured to determine a payload type and a payload size for the second SEI message based on metadata to be conveyed. Video encoder 200 may be configured to format syntax elements of the second SEI message, including the second PO SEI wrapping flag and the second PO SEI prefix flag, into a sequence of bits according to a syntax structure associated with the payload type. Formatting the syntax elements may include converting values of the syntax elements into binary representations, such as unsigned integer codes or variable-length Exp-Golomb codes. Video encoder 200 may be configured to group the sequence of bits into a byte-aligned payload.

In some examples, video encoder 200 may be configured to apply an emulation prevention process to the byte-aligned payload to produce an encapsulated payload. The emulation prevention process may include inserting emulation prevention bytes into the byte-aligned payload so that bit patterns matching start code prefixes do not accidentally occur within the encapsulated payload. Video encoder 200 may be configured to generate a NAL unit header containing a NAL unit type value that identifies the non-VCL NAL unit as an SEI NAL unit. Video encoder 200 may be configured to prepend the NAL unit header to the encapsulated payload to form a complete SEI NAL unit. Video encoder 200 may be configured to multiplex the SEI NAL unit into an encoded video bitstream alongside VCL NAL units containing coded picture data. By inserting the SEI NAL unit into an access unit of the encoded video bitstream, video encoder 200 may be configured to encode the second SEI message for output to a storage device or for transmission to a decoding device, such as video decoder 300.

In an example, video decoder 300 may be configured to receive a plurality of SEI messages related to video data, wherein the plurality of SEI messages includes at least a first SEI message and a second SEI message. The first SEI message may include first syntax elements comprising a first PO SEI wrapping flag (e.g., po_sei_wrapping_flag[i]) and a first PO SEI prefix flag (e.g., po_sei_prefix_flag[i]). The first syntax elements (e.g., po_sei_wrapping_flag[i], po_sei_prefix_flag[i], etc.) may be indexed by a first index variable (e.g., index variable i). The second SEI message may include second syntax elements comprising a second PO SEI wrapping flag (e.g., po_sei_wrapping_flag[j]) and a second PO SEI prefix flag (e.g., po_sei_prefix_flag[j]). The second syntax elements (e.g., po_sei_wrapping_flag[j], po_sei_prefix_flag[j], etc.) may be indexed by a second index variable (e.g., index variable j) distinct from the first index variable. Video decoder 300 may be configured to determine to apply a constraint on a presence of the second SEI message in an SPO SEI message based on the first syntax elements (e.g., po_sei_wrapping_flag[i], po_sei_prefix_flag[i], etc.) and the second syntax elements (e.g., po_sei_wrapping_flag[j], po_sei_prefix_flag[j], etc.).

Determining to apply the constraint may include using at least one set of index values including a first value for the first index variable (e.g., index variable i) and a second value for the second index variable (e.g., index variable j), where the first value is different from the second value. In other words, the value of index variable i may equal the value of index variable j for some comparisons, and the value of index variable i may be different from the value of index variable j for some comparisons. In this manner, video decoder 300 can determine whether the constraint applies in situations where i≠j, rather than being limited to applying the constraint only in situations where i=j.

In some examples, video decoder 300 may determine that the first PO SEI wrapping flag (e.g., po_sei_wrapping_flag[i]) and the first PO SEI prefix flag (e.g., po_sei_prefix_flag[i]) are equal to zero and further determine to apply the constraint on the presence of the second SEI message in the SPO SEI message based on these determined values. In some examples, video decoder 300 may be configured to determine to apply the constraint when the following conditions are also met: (i) a first PO SEI payload type flag (e.g., po_sei_payload_type[i]) of the first SEI message is equal to a second PO SEI payload type flag (e.g., po_sei_payload_type[j]) of the second SEI message; (ii) the second PO SEI wrapping flag (e.g., po_sei_wrapping_flag[j]) is equal to zero; and the second PO SEI prefix flag (e.g., po_sei_prefix_flag[j]) is equal to one. Applying the constraint may prevent the second SEI message from being present in the SPO SEI message, which may ensure accurate video data reproduction across various CLVSs.

Video decoder 300 may decode the second SEI message based on the constraint. For example, video decoder 300 may be configured to receive an encoded video bitstream and extract a sequence of NAL units. Video decoder 300 may examine a NAL unit header of each extracted NAL unit to identify non-VCL NAL units that include SEI messages based on a specific NAL unit type value. Upon identifying an SEI NAL unit, video decoder 300 may be configured to apply an emulation prevention removal process to an encapsulated payload of the SEI NAL unit. The emulation prevention removal process may include detecting and removing emulation prevention bytes that were inserted during encoding to prevent accidental start code patterns, thereby recovering an original byte-aligned payload.

Video decoder 300 may be configured to parse the original byte-aligned payload to determine a payload type and a payload size. Based on the payload type, video decoder 300 may be configured to identify a syntax structure of the second SEI message and extracts corresponding syntax elements, including the second PO SEI wrapping flag and the second PO SEI prefix flag. Video decoder 300 may be configured to convert binary representations of the corresponding syntax elements back into semantic values.

By interpreting the semantic values in accordance with an established processing order and the constraint, video decoder 300 may determine how metadata within the second SEI message is applied to subsequent decoding, display, or post-processing operations for associated coded pictures. For example, in instances where video decoder 300 receives a non-conforming bitstream containing invalid message combinations that violate the applied constraint, video decoder 300 may execute an error handling operation. Upon detecting that the second SEI message violates the constraint based on the evaluation of the first index variable and the distinct second index variable, video decoder 300 may discard the non-conforming second SEI message to prevent processing sequence errors. Video decoder 300 may proceed to parse subsequent NAL units in the encoded video bitstream without applying the metadata of the discarded second SEI message to the associated coded pictures.

In some examples that involve wrapping, a prefix may not be needed. In such examples, video decoder 300 may parse the PON-nested SEI message regardless of whether the prefix indication is present or not. In case of multiple PON-nested film grain characteristics (FGC) SEI messages with different picture resolution extension present in PON SEI message, an SPO SEI message may indicate these PON-nested FGC SEI messages with the same payload type without prefix indication. Video decoder 300 may be configured to operate as follows. When an SPO SEI message indicates different PON-nested SEI message types with the same payload type and the associated po_sei_prefix_flag equal to 0, the processing order of these PON-nested SEI message types should be the same, and video decoder 300 may operate on a single one of the PON-nested SEI message type.

An encoder, such as video encoder 200, can include multiple PON SEI messages in the same access unit. For example, a first PON SEI message in an access unit can contain a PON-nested SEI message that applies to multiple processing chains and one or more other PON SEI messages in the same access unit that apply to a single processing chain only. An SPO SEI message can indicate multiple PON-nested SEI messages, and these PON-nested SEI messaged may be specified in different PON SEI messages which may cause parsing complexity.

In some examples, video encoder 200 and video decoder 300 may be configured to process SEI messages in accordance with semantics in which the pon_target_po_id syntax element may be constrained as follows so that the PON-nested SEI messages indicated in the same SPO SEI message are specified in a single PON SEI message. When more than one PON SEI messages is present in an access unit, the value of pon_target_po_id[i] for any value of i in the range of 0 to pon_num_po_ids_minus1, inclusive, of a PON SEI message is not be equal to the value pon_target_po_id[j] for any value of j in the range of 0 to pon_num_po_ids_minus1, inclusive, of a different PON SEI message.

In some examples, video encoder 200 and video decoder 300 may be configured to process SEI messages in accordance with semantics in which, when more than one PON SEI messages is present in an access unit, the value of pon_target_po_id is different in different PON SEI messages.

In some examples, video encoder 200 and video decoder 300 may be configured to process SEI messages in accordance with semantics in which, when a PON-nested PON SEI message is specified in a PON SEI message, a constraint for uniqueness may apply as follows. The value of pon_processing_order of the PON-nested SEI message with the same SEI message type is different in a PON SEI message. An alternative phrasing and/or modification of this constraint is provided below.

In some examples, video encoder 200 and video decoder 300 may be configured to process SEI messages in accordance with semantics in which, when any of the following conditions is true for any values of i and j in the range of 0 . . . pon_num_seis_minus1+1, the i-th and j-th types of SEI messages indicated in a PON SEI message, where i-th SEI message is indicated in an SPO SEI message with associated syntax elements po_sei_payload_type[m], po_sei_prefix_flag[m] and po_sei_prefix_data_bit[m], and j-th SEI message is indicated in a different SPO SEI message with associated syntax elements po_sei_payload_type[n], po_sei_prefix_flag[n] and po_sei_prefix_data_bit[n], are considered different types of SEI messages:
po_sei_payload_type[m] is not equal to po_sei_payload_type[n]; po_sei_prefix_flag[m] is equal to 1, po_sei_prefix_flag[n] is equal to 1, and at least po_sei_prefix_data_bit[m][k] is not equal to po_sei_prefix_data_bit[n][k] for any value of k in the range of 0 . . . Min(po_num_bits_prefix_indication_minus1[m], po_num_bits_prefix_indication_minus1[n]); or po_sei_wrapping_flag[m] is equal to 1, po_sei_wrapping_flag[n] is equal to 1, and po_sei_processing_order[m] is not equal to po_sei_processing_order[n].

In some examples, video encoder 200 and video decoder 300 may be configured to process SEI messages in accordance with semantics in which, for each value of i in the range of 0 . . . pon_num_seis_minus1+1 and each value of j in the range of 0 . . . pon_num_seis_minus1+1 and not equal to i, the i-th and j-th types of SEI messages indicated in a PON SEI message are different from each other.

In some examples, the PON-nested SEI message type may be specified as follows.

The semantics of the SPO SEI message may be based on types of SEI messages. SEI messages that have different payload type values may be considered different types of SEI messages. Additionally or alternatively, different SEI messages that have the same payload type value but are differentiated by values of syntax elements in the SEI payload may be considered different types of SEI messages. Such differentiation by values of syntax elements in the SEI payload may be performed by comparing values sent using po_sei_prefix_data_bit[i][j] syntax elements (when present) or values sent as SEI messages within a processing order nesting SEI message and the associated pon_processing_order value (when present). For example, neural-network post-filter characteristics (NNPFC) SEI messages can be differentiated by having different nnpfc_id values, or by the associated pon_processing_order value when encapsulated in a PON SEI message. In some examples, video encoder 200 and video decoder 300 may be configured to process SEI messages in accordance with semantics in which the types of SEI messages indicated in an SPO SEI message are different from each other. In some examples, video encoder 200 and video decoder 300 may be configured to process SEI messages in accordance with semantics in which the types of PON-nested SEI messages indicated in a PON SEI message are different from each other.

Various constraints may apply to the dependency between the PON-nested SEI message and non-PON-nested SEI message. Examples of such constraints are provided below.

In some examples, video encoder 200 and video decoder 300 may be configured to process SEI messages in accordance with semantics in which, when a film grain characteristics SEI message is present with fg_characteristics_persistence_flag equal to 1 that is not a PON-nested SEI message, there is not an associated film grain characteristics SEI message in the same CLVS with fg_characteristics_cancel_flag equal to 1 that is a PON-nested SEI message.

In some examples, video encoder 200 and video decoder 300 may be configured to process SEI messages in accordance with semantics in which, when a content color volume SEI message is present with ccv_persistence_flag equal to 1 that is not a PON-nested SEI message, there is not an associated content color volume SEI message in the same CLVS with ccv_cancel_flag equal to 1 that is a PON-nested SEI message.

In some examples, video encoder 200 and video decoder 300 may be configured to process SEI messages in accordance with semantics in which, when an equirectangular projection SEI message is present with erp_persistence_flag equal to 1 that is not a PON-nested SEI message, there is not an associated equirectangular projection SEI message in the same CLVS with erp_cancel_flag equal to 1 that is a PON-nested SEI message.

In some examples, video encoder 200 and video decoder 300 may be configured to process SEI messages in accordance with semantics in which, when a generalized cubemap projection SEI message is present with gcmp_persistence_flag equal to 1 that is not a PON-nested SEI message, there is not an associated generalized cubemap projection SEI message in the same CLVS with gcmp_cancel_flag equal to 1 that is a PON-nested SEI message.

In some examples, video encoder 200 and video decoder 300 may be configured to process SEI messages in accordance with semantics in which, when a region-wise packing SEI message is present with rwp_persistence_flag equal to 1 that is not a PON-nested SEI message, there is not an associated region-wise packing SEI message in the same CLVS with rwp_cancel_flag equal to 1 that is a PON-nested SEI message.

In some examples, video encoder 200 and video decoder 300 may be configured to process SEI messages in accordance with semantics in which, when a sample aspect ratio SEI message is present with sari_persistence_flag equal to 1 that is not a PON-nested SEI message, there is not an associated sample aspect ratio SEI message in the same CLVS with sari_cancel_flag equal to 1 that is a PON-nested SEI message.

In some examples, video encoder 200 and video decoder 300 may be configured to process SEI messages in accordance with semantics in which, when an annotated regions SEI message is present that is not a PON-nested SEI message, there is not an associated annotated regions SEI message in the same CLVS with ar_cancel_flag equal to 1 that is a PON-nested SEI message.

In some examples, video encoder 200 and video decoder 300 may be configured to process SEI messages in accordance with semantics in which, when an alpha channel information SEI message is present that is not a PON-nested SEI message, there is not an associated alpha channel information SEI message in the same CLVS with alpha_channel_cancel_flag equal to 1 that is a PON-nested SEI message.

In some examples, video encoder 200 and video decoder 300 may be configured to process SEI messages in accordance with semantics in which, when a display orientation SEI message is present with display_orientation_persistence_flag equal to 1 that is not a PON-nested SEI message, there is not an associated display orientation SEI message in the same CLVS with display_orientation_cancel_flag equal to 1 that is a PON-nested SEI message.

In some examples, video encoder 200 and video decoder 300 may be configured to process SEI messages in accordance with semantics in which, when an object mask information SEI message is present with omi_persistence_flag equal to 1 that is not a PON-nested SEI message, there is not an associated object mask information SEI message in the same CLVS with omi_cancel_flag equal to 1 that is a PON-nested SEI message.

In some examples, video encoder 200 and video decoder 300 may be configured to process SEI messages in accordance with semantics in which, when a modality information SEI message is present with mi_modality_info_persistence_flag equal to 1 that is not a PON-nested SEI message, there is not an associated modality information SEI message in the same CLVS with mi_modality_info_cancel_flag equal to 1 that is a PON-nested SEI message.

In some examples, video encoder 200 and video decoder 300 may be configured to process SEI messages in accordance with semantics in which, when an AI usage restriction information SEI message is present with aur_persistence_flag equal to 1 that is not a PON-nested SEI message, there is not an associated AI usage restriction information SEI message in the same CLVS with aur_cancel_flag equal to 1 that is a PON-nested SEI message.

Additional examples may include one or more of the following constraints.

In some examples, video encoder 200 and video decoder 300 may be configured to process SEI messages in accordance with semantics in which, when a generalized cubemap projection SEI message is present with gcmp_persistence_flag equal to 1 that is not a PON-nested SEI message, there is not an associated generalized cubemap projection SEI message in the same CLVS that is a PON-nested SEI message.

In some examples, video encoder 200 and video decoder 300 may be configured to process SEI messages in accordance with semantics in which, when an object mask information SEI message is present with omi_persistence_flag equal to 1 that is not a PON-nested SEI message, there is not an associated object mask information SEI message in the same CLVS that is a PON-nested SEI message.

In some examples, video encoder 200 and video decoder 300 may be configured to process SEI messages in accordance with semantics in which, when a modality information SEI message is present with mi_modality_info_persistence_flag equal to 1 that is not a PON-nested SEI message, there is not an associated modality information SEI message in the same CLVS that is a PON-nested SEI message.

In some examples, video encoder 200 and video decoder 300 may be configured to process SEI messages in accordance with semantics in which, when an AI usage restriction information SEI message is present with aur_persistence_flag equal to 1 that is not a PON-nested SEI message, there is not an associated AI usage restriction information SEI message in the same CLVS that is a PON-nested SEI message.

SPO syntax element, po_sei_wrapping_flag, may be configured to prevent SEI messages from being incorrectly interpreted by decoders that do not process SPO SEI messages. However, SEI messages specified after VSEI v4 may be incorrectly interpreted by decoders that process SPO SEI messages. The techniques of this disclosure may involve signaling enhancements that resolve the foregoing issue.

According to the techniques of this disclosure, a syntax element may be included to indicate the largest VSEI version number of the SEI messages or PON-nested SEI message indicated by an SPO or PON SEI message. An example syntax structure is provided below that includes the syntax element, spo_vsei_version, to indicate largest VSEI version number of the SEI messages or PON-nested SEI message indicated by an SPO or PON SEI message.

| | |
|---|---|
| if( more_data_in_payload( ) ) | |
| if(payload_extension_present( )) { | |
| SeiExtensionBitsPresentFlag = 1 | |
| spo_vsei_version <added text> | u(8) |
| } | |

The syntax element spo_vsei_version indicates the largest VSEI version number of the SEI messages indicated by the SPO SEI message. By explicitly signaling the largest VSEI version number associated with the SEI messages or PON-nested SEI messages, video decoder 300 can verify version compatibility before attempting to parse or execute the messages. This may prevent SEI messages defined in future VSEI versions from being incorrectly interpreted or applied by legacy decoding devices that only support older specifications, thereby avoiding processing errors and ensuring robust video reconstruction.

In an example, an encoding device, such as video encoder 200, may generate an SPO SEI message indicating a processing chain containing multiple SEI messages, where the most recent SEI message type requires VSEI version 8. Video encoder 200 may encode the spo_vsei_version syntax element with a value corresponding to VSEI version 8. Upon receiving the bitstream, a decoding device, such as video decoder 300, parses the spo_vsei_version syntax element and compares the indicated version to a locally supported VSEI version. In this example, if video decoder 300 operates according to VSEI version 4, video decoder 300 may determine a version mismatch exists and skip application of the entire processing chain indicated by the SPO SEI message, thereby avoiding processing errors associated with unsupported SEI message types.

In some examples, to maintain bitstream conformance, video encoder 200 and video decoder 300 may be configured to process SEI messages in accordance with semantics in which spo_vsei_version is associated with at least one SEI message indicated in the SPO SEI message.

In some examples, spo_vsei_version may indicate the largest VSEI version number of the PON-nested SEI messages indicated by the SPO SEI message. In some examples, to maintain bitstream conformance, video encoder 200 and video decoder 300 may be configured to process SEI messages in accordance with semantics in which spo_vsei_version is associated with at least one PON-nested SEI message indicated in the SPO SEI message.

In some examples, spo_vsei_version may indicate the largest VSEI version number of the SEI message which the decoding system should not apply the processing chain if it cannot interpret or does not support this SEI message.

In some examples, a number of VSEI version number may be specified to indicate the VSEI version numbers of associated SEI messages indicated in SPO SEI message as provided in the following example syntax structure.

| | |
|---|---|
| if( more_data_in_payload( ) ) | |
| if(payload_extension_present( )) { | |
| SeiExtensionBitsPresentFlag = 1 | |
| spo_num_vsei_version_minus1 | u(8) |
| for( i = 0; i <= spo_num_vsei_version_minus1; i++) | |
| spo_vsei_version[i] <added text> | u(8) |
| } | |

In some examples, the syntax element spo_num_vsei_version_minus1 plus 1 indicates the number of VSEI versions associated with the SEI messages indicated in the SPO SEI message.

In some examples, the syntax element spo_num_vsei_version_minus1 plus 1 indicates the number of VSEI versions associated with the PON-nested SEI messages indicated in the SPO SEI message.

The syntax element spo_vsei_version[i] can be used to indicate the i-th VSEI version number.

In some examples, to maintain bitstream conformance, video encoder 200 and video decoder 300 may be configured to process SEI messages in accordance with semantics in which at least one SEI message indicated in the SPO SEI message is associated with the i-th VSEJ version number, where i is in the range of 0 to spo_num_vsei_version_minus1, inclusive.

In some examples, to maintain bitstream conformance, video encoder 200 and video decoder 300 may be configured to process SE messages in accordance with semantics in which at least one PON-nested SEI message indicated in the SPO SEI message is associated with the i-th VSEI version number, where i is in the range of 0 to spo_num_vsei_version_minus1, inclusive.

In some examples, the VSEJ description may be added to TDI SE message. An example is provided below.

TABLE 33
Definition of tdi_descr_purpose

| Value | Interpretation |
|---|---|
| 0 | Application defined |
| 1 | Copyright information |
| 2 | AI marking information |
| 3 | General comment information |
| 4 | Content advisory rating information conforming to |
| | US and Canadian Rating Region Tables (RRT) |
| 5 | Tag URI for identifying the bitstream to which the |
| | coded picture(s) in the persistence scope of this |
| | SEI message belong or have belonged |
| 6 | Encoder description |
| 7 | VSEI description |
| 8 . . . 255 | Reserved |

The syntax element tdi_descr_purpose indicates the purpose of the text description information SEI message as specified in Table 33. In some examples, the value of tdi_descr_purpose is in the range of 0 to 7, inclusive. Values in the range of 8 to 255, inclusive, for tdi_descr_purpose may be reserved for future use by ITU-T ISO/IEC and may not be present in bitstreams conforming to the VSEI standard. Decoders conforming to the VSEI standard may allow any value of tdi_descr_purpose in the range of 0 to 255, inclusive.

When tdi_descr_purpose is equal to 7, tdi_descr_string[i] indicates a description of the VSEI specification associated with the SEI messages in the persistence scope of this SEI message.

In some examples, processing circuitry (e.g., processing circuitry of video encoder 200) may be configured to generate and/or encode SEI messages including syntax elements as described above.

In some examples, processing circuitry (e.g., processing circuitry of video decoder 300) may be configured to receive and/or decode at least one SEI message of a bitstream, the SEI message including one or more syntax elements. The processing circuitry may be further configured to control the processing of one or more other SEI messages based on the one or more syntax elements. For example, the processing circuitry may be configured to apply a constraint (such as any of the constraints described above) on the processing of the one or more other SEI messages based on the one or more syntax elements.

In this manner, video encoder 200 may generate a bitstream including encoded video data, e.g., syntax elements describing partitioning of a picture into blocks (e.g., CUs) and prediction and/or residual information for the blocks. Video encoder 200 may further generate the bitstream to include one or more SEI messages as discussed above. Ultimately, video decoder 300 may receive the bitstream and decode the encoded video data. Likewise, video decoder 300 may process one or more of the SEI messages, e.g., according to an SPO that may include various constraints as described above.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

Any of the video encoding or video decoding processes described above may be performed using a neural network (NN). Additionally or alternatively, a neural network may be trained to efficiently compress video data without necessarily separately performing prediction and residual coding. Studies have shown that embedding neural networks into the hybrid video coding framework of video encoder 200 and video decoder 300 can improve compression efficiency. Neural networks may be used for intra-prediction and inter-prediction to improve the prediction efficiency. NN-based in-loop filtering and/or post-filtering have also performed well in heuristic testing.

For example, video encoder 200 and video decoder may use one or more NN-based filters for existing filters, such as deblocking filters, sample adaptive offset (SAO), and/or adaptive loop filtering (ALF). NN-based filters can also be applied exclusively, where NN-based filters are designed to replace all of the existing filters. Additionally or alternatively, NN-based filters may be designed to supplement, enhance, or replace any or all of the other filters.

In some examples, an NN-based filter may be a convolutional neural network (CNN)-based filter with multiple layers. An NN-based filtering process may take reconstructed samples as inputs, and may add the intermediate outputs back to the inputs to refine the input samples. The NN-based filter may use all color components (e.g., Y, U, and V, or Y, Cb, and Cr) as inputs 172 to exploit cross-component correlations. Different color components may share the same filters (including network structure and model parameters) or each component may have its own specific filters.

The filtering process can also be generalized as follows:

R′(i,j)=R(i,j)+NN_filter_residual_ouput(R)

Here, R(i, j) represents a reconstructed sample at position (i, j) in the picture, R′(i, j) represents the filtered version of the reconstructed sample, and NN_filter_residual_output(R) represents the intermediate samples discussed above that are calculated by the NN filter. The model structure and model parameters of NN-based filter(s) can be pre-defined and be stored at video encoder 200 and video decoder 300. The filters can also be signalled in the bitstream.

In some examples, an NN-based filter may include a series of feature extraction layers, followed by an output convolution. The feature extraction layers may include a 3×3 convolution (conv) layer followed by a parametric rectified linear unit (PReLU) layer. The convolutional layer applies a convolution operation to the input data, which involves a filter or kernel processing the input data (e.g., the reconstruction samples) in a sliding window fashion and computing dot products at each position. The convolution operation may capture local patterns within the input data. For example, in the context of image processing, these patterns could be edges, textures, or other visual features.

The filter or kernel is a small matrix of weights that gets updated during the training process. By sliding this filter across the input data (or feature map from a previous layer) and computing the dot product at each position, the convolutional layer creates a feature map that encodes spatial hierarchies and patterns detected in the input. The output of a convolutional layer is a set of feature maps, each corresponding to one filter, capturing different aspects of the input data. This layer helps the neural network to learn increasingly complex and abstract features as the data passes through deeper layers of the network.

The PReLU layer is an activation function used in neural networks, and is a variant of the rectified linear unit (ReLU) activation function. As described above, the convolution layer outputs feature maps, each corresponding to one filter, representing detected features in the input. Following the convolution layer, the PReLU layer applies the PReLU activation function to each element of the feature maps produced by the convolution layer. For positive values, the PReLU layer acts like a standard ReLU, passing the value through. For negative values, instead of setting them to zero (e.g., as ReLU does), the PReLU layer allows a small, linear, negative output. This keeps neurons of the NN active and maintains the gradient flow, which can be beneficial for learning in deep networks.

When NN-based filtering is applied in video coding, the whole video signal (pixel data) may be split into multiple processing units (e.g., 2D blocks), and each processing unit can be processed separately or be combined with other information associated with this block of pixels. For example, a processing unit may be a frame, a slice/tile, a CTU, or any pre-defined or signaled shapes and sizes. Typically, NN-based filtering is performed on reconstructed blocks of video data. Here, reconstructed blocks and samples may refer to both decoded blocks produced by video decoder 300, as well blocks reconstructed in a reconstruction loop of video encoder 200.

To further improve the performance of NN-based filtering, different types of input data can be processed jointly to produce the filtered output. Input data may include, but is not limited to, reconstruction pixels/samples, prediction pixels/samples, pixels/samples after the loop filter(s), partitioning structure information, deblocking parameters (e.g., boundary strength (BS)), quantization parameter (QP) values, slice or picture types, or a filters applicability or coding modes map. Input data can be provided at different granularities. Luma reconstruction and prediction samples may be provided at the original resolution, whereas chroma samples may be provided at lower resolution, e.g. for 4:2:0 representation, or can be up-sampled to the Luma resolution to achieve per-pixel representation. Similarly, QP, BS, partitioning, or coding mode information can be provided at lower resolution, including cases with a single value per frame, slice or processing block (e.g. QP). In other examples, QP, BS, partitioning, or coding mode information can be expanded (e.g., replicated) to achieve per-pixel/sample representation.

To further improve the performance of NN-based filtering, multi-mode solutions can be used. For example, for each processing unit, video encoder 200 may select a mode from a set of modes based on rate-distortion optimization and signal the selected mode in the bit-stream. The different modes may include different NN models, different values that may be used as the input information of the NN models, etc. In one example, video encoder 200 and video decoder 300 may use an NN-based filtering solution with multiple modes based on a single NN model by using different QP values as input to the NN model for different modes.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

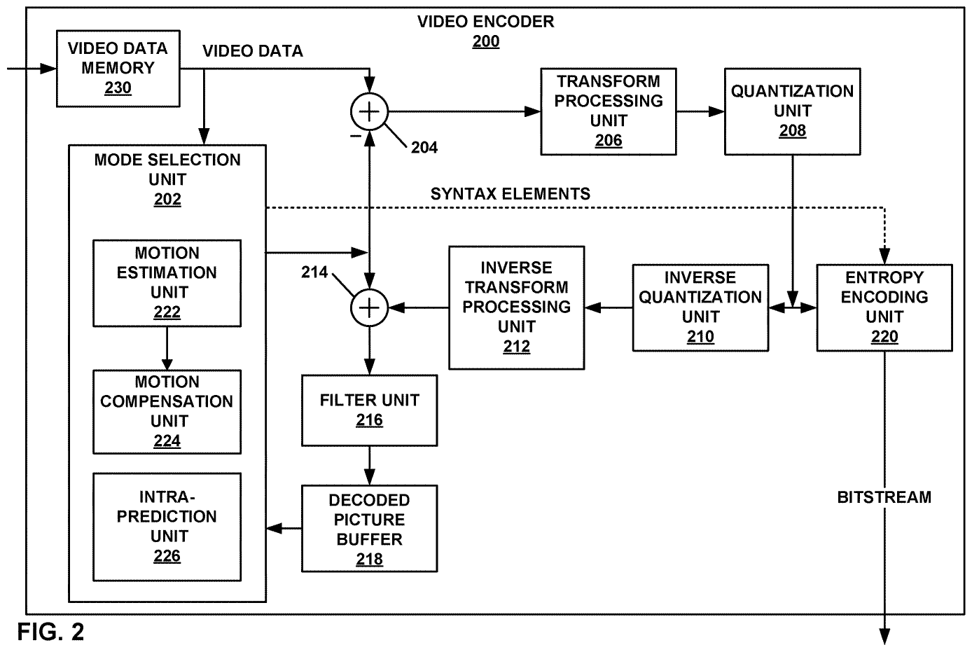

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC (ITU-T H.266) and HEVC (ITU-T H.265). However, the techniques of this disclosure may be performed by video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure, superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra-prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra-prediction, non-directional intra-prediction, recursive filter intra-prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra-prediction, and symmetric PU sizes of 2N×2N, 2N×N, N×2N, N×N, or similar for inter-prediction. Video encoder 200 and video decoder 300 may also support asymmetric partitioning for PU sizes of 2N×nU, 2N×nD, nL×2N, and nR×2N for inter-prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 may also encode one or more SEI messages per any of the various techniques of this disclosure, alone or in any combination.

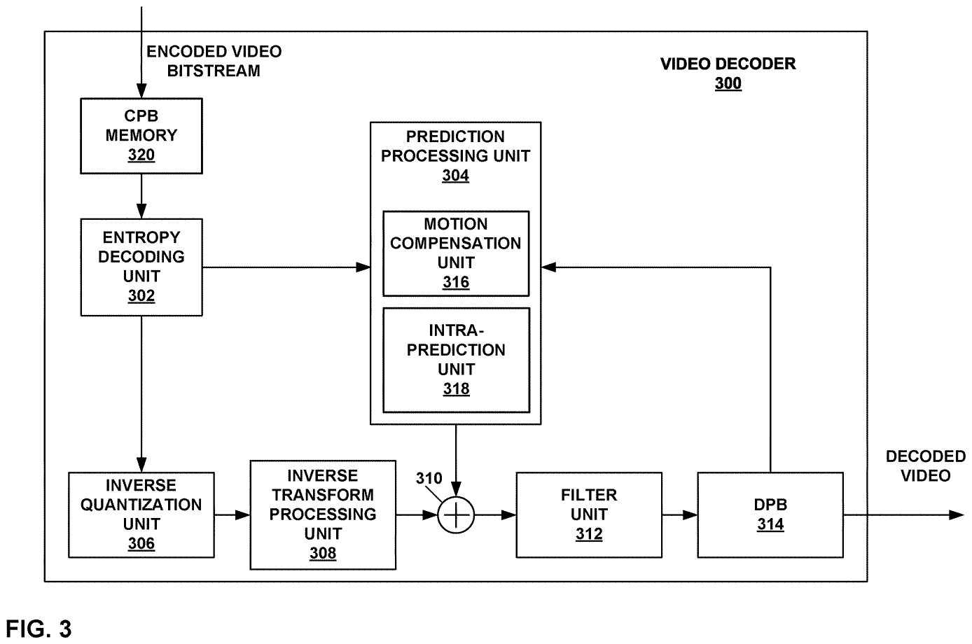

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC (ITU-T H.266) and HEVC (ITU-T H.265). However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra-prediction, as described above. Intra-prediction unit 318 may be configured to decode coding blocks of video data (e.g., both luma and chroma coding blocks) using directional intra-prediction, non-directional intra-prediction, recursive filter intra-prediction, CFL, intra block copy (IBC), and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may each be provided by the same memory device or separate memory devices or memory units. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

Following extraction and parsing of non-VCL NAL units by entropy decoding unit 302, video decoder 300 may store extracted SEI messages, including SPO SEI messages and PON SEI messages, in CPB memory 320 or another dedicated metadata buffer within memory 120. Video decoder 300 may retrieve the stored SEI messages from memory 120 to apply the indicated processing chains, such as neural-network post-filters or film grain characteristics, to the decoded pictures output from DPB 314 prior to presentation on display device 118. Storing the parsed SEI messages in memory 120 may maintain synchronization of the metadata with the corresponding decoded pictures during presentation.

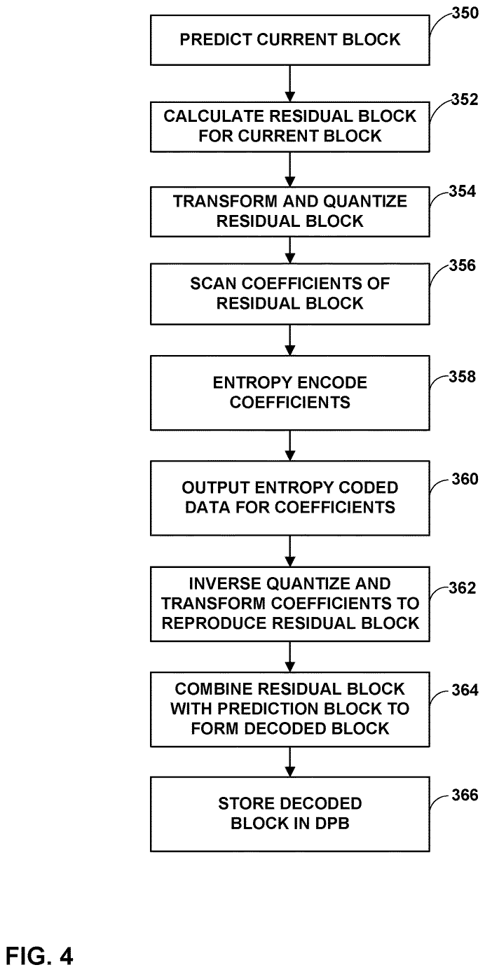

FIG. 4 is a flowchart illustrating an example method for encoding a current block in accordance with the techniques of this disclosure. The current block may include a current CU. Although described with respect to video encoder 200 (FIGS. 1 and 2), it should be understood that other devices may be configured to perform a method similar to that of FIG. 4.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, uncoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

Video encoder 200 may also decode the current block after encoding the current block, to use the decoded version of the current block as reference data for subsequently coded data (e.g., in inter- or intra-prediction modes). Thus, video encoder 200 may inverse quantize and inverse transform the coefficients to reproduce the residual block (362). Video encoder 200 may combine the residual block with the prediction block to form a decoded block (364). Video encoder 200 may then store the decoded block in DPB 218 (366).

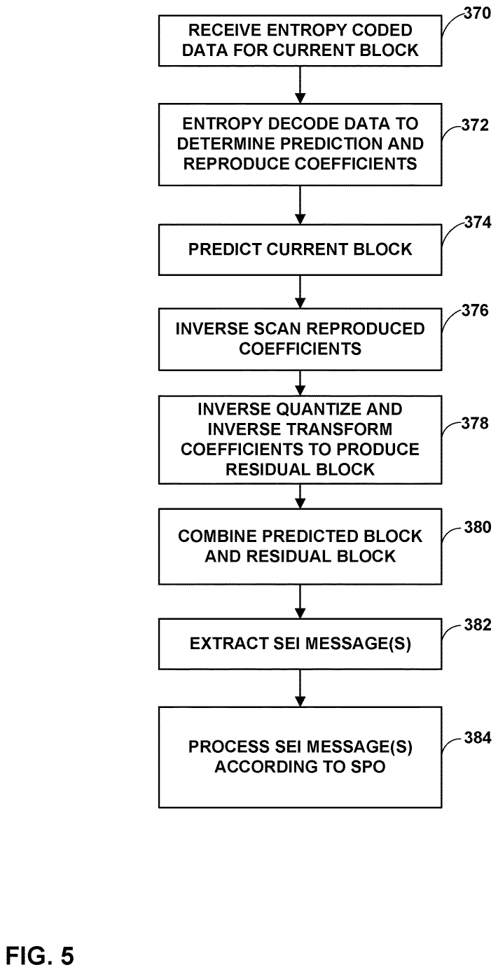

FIG. 5 is a flowchart illustrating an example method for decoding a current block of video data in accordance with the techniques of this disclosure. The current block may include a current CU. Although described with respect to video decoder 300 (FIGS. 1 and 3), it should be understood that other devices may be configured to perform a method similar to that of FIG. 5.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

Per techniques of this disclosure, video decoder 300 may also extract one or more SEI messages from a bitstream including the current block and other video data (382). Video decoder 300 may decode or otherwise process the extracted SEI message(s) according to an SPO that may include various constraints, as described above. (384).

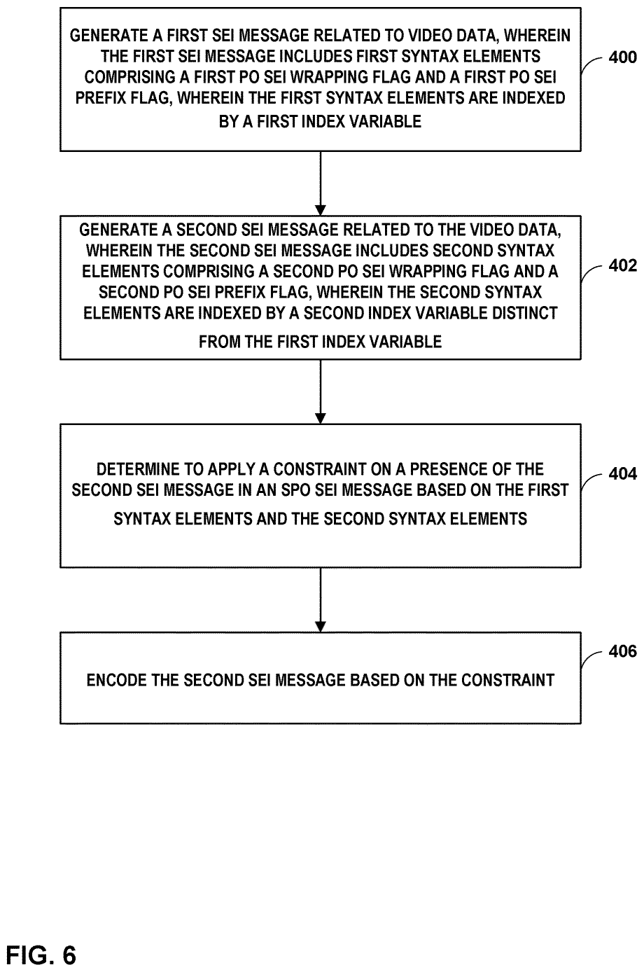

FIG. 6 is a flowchart illustrating an example method for encoding SEI messages related to video data (e.g., one or more video blocks and/or other portions of a video bitstream being encoded by video encoder 200), in accordance with the techniques of this disclosure. Although described with respect to video encoder 200 (FIGS. 1 and 2), it should be understood that other devices may be configured to perform a method similar to that of FIG. 6.

In the example of FIG. 6, video encoder 200 generates a first SEI message related to the video data (400). The first SEI message may include first syntax elements comprising a first PO SEI wrapping flag (e.g., po_sei_wrapping_flag[i]) and a first PO SEI prefix flag (e.g., po_sei_prefix_flag[i]). The first syntax elements (e.g., po_sei_wrapping_flag[i], po_sei_prefix_flag[i], etc.) may be indexed by a first index variable (e.g., index variable i).

Video encoder 200 may also generate a second SEI message related to the video data (402). The second SEI message may include second syntax elements comprising a second PO SEI wrapping flag (e.g., po_sei_wrapping_flag[j]) and a second PO SEI prefix flag (e.g., po_sei_prefix_flag[j]). The second syntax elements (e.g., po_sei_wrapping_flag[j], po_sei_prefix_flag[j], etc.) may be indexed by a second index variable (e.g., index variable j) distinct from the first index variable.

Video encoder 200 may determine to apply a constraint on a presence of the second SEI message in an SPO SEI message based on the first syntax elements (e.g., po_sei_wrapping_flag[i], po_sei_prefix_flag[i], etc.) and the second syntax elements (e.g., po_sei_wrapping_flag[j], po_sei_prefix_flag[j], etc.) (404). Determining to apply the constraint may include using at least one set of index values including a first value for the first index variable (e.g., index variable i) and a second value for the second index variable (e.g., index variable j), where the first value is different from the second value. In other words, the value of index variable i may equal the value of index variable j for some comparisons, and the value of index variable i may be different from the value of index variable j for some comparisons. In this manner, video encoder 200 can determine whether the constraint applies in situations where i j, rather than being limited to applying the constraint only in situations where i=j.

In some examples, video encoder 200 may determine that the first PO SEI wrapping flag (e.g., po_sei_wrapping_flag[i]) and the first PO SEI prefix flag (e.g., po_sei_prefix_flag[i]) are equal to zero and further determine to apply the constraint on the presence of the second SEI message in the SPO SEI message based on these determined values. In some examples, video encoder 200 may determine to apply the constraint when the following conditions are also met: (i) a first PO SEI payload type flag (e.g., po_sei_payload_type[i]) of the first SEI message is equal to a second PO SEI payload type flag (e.g., po_sei_payload_type[j]) of the second SEI message; (ii) the second PO SEI wrapping flag (e.g., po_sei_wrapping_flag[j]) is equal to zero; and the second PO SEI prefix flag (e.g., po_sei_prefix_flag[j]) is equal to one.

Applying the constraint may prevent the second SEI message from being present in the SPO SEI message. In some examples, the SPO SEI message may include the first SEI message. In other examples, the SPO SEI message may be in a same CLVS as a different SPO SEI message that includes the first SEI message.

Video encoder 200 may encode the second SEI message based on the constraint (406). For example, video encoder 200 may generate a non-VCL NAL unit. Video encoder 200 may determine a payload type and a payload size for the second SEI message based on metadata to be conveyed. Video encoder 200 may format syntax elements of the second SEI message, including the second PO SEI wrapping flag and the second PO SEI prefix flag, into a sequence of bits according to a syntax structure associated with the payload type. Formatting the syntax elements may include converting values of the syntax elements into binary representations, such as unsigned integer codes or variable-length Exp-Golomb codes. Video encoder 200 may group the sequence of bits into a byte-aligned payload.

In some examples, video encoder 200 may apply an emulation prevention process to the byte-aligned payload to produce an encapsulated payload. The emulation prevention process may include inserting emulation prevention bytes into the byte-aligned payload so that bit patterns matching start code prefixes do not accidentally occur within the encapsulated payload. Video encoder 200 may generate a NAL unit header containing a NAL unit type value that identifies the non-VCL NAL unit as an SEI NAL unit. Video encoder 200 may prepend the NAL unit header to the encapsulated payload to form a complete SEI NAL unit. Video encoder 200 may multiplex the SEI NAL unit into an encoded video bitstream alongside VCL NAL units containing coded picture data. By inserting the SEI NAL unit into an access unit of the encoded video bitstream, video encoder 200 may encode the second SEI message for output to a storage device or for transmission to a decoding device, such as video decoder 300.

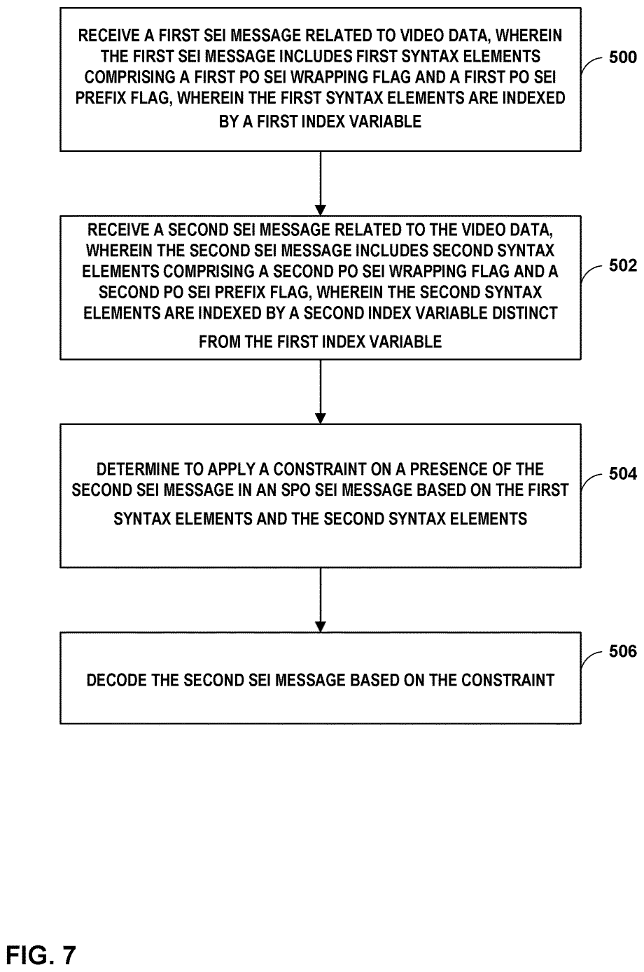

FIG. 7 is a flowchart illustrating an example method for decoding SEI messages related to video data (e.g., one or more video blocks and/or other portions of a video bitstream being decoded by video decoder 300), in accordance with the techniques of this disclosure. Although described with respect to video decoder 300 (FIGS. 1 and 3), it should be understood that other devices may be configured to perform a method similar to that of FIG. 7.

In the example of FIG. 7, video decoder 300 receives a first SEI message related to the video data (500). The first SEI message may include first syntax elements comprising a first PO SEI wrapping flag (e.g., po_sei_wrapping_flag[i]) and a first PO SEI prefix flag (e.g., po_sei_prefix_flag[i]). The first syntax elements (e.g., po_sei_wrapping_flag[i], po_sei_prefix_flag[i], etc.) may be indexed by a first index variable (e.g., index variable i).

Video decoder 300 may also receive a second SEI message related to the video data (502). The second SEI message may include second syntax elements comprising a second PO SEI wrapping flag (e.g., po_sei_wrapping_flag[j]) and a second PO SEI prefix flag (e.g., po_sei_prefix_flag[j]). The second syntax elements (e.g., po_sei_wrapping_flag[j], po_sei_prefix_flag[j], etc.) may be indexed by a second index variable (e.g., index variable j) distinct from the first index variable.

Video decoder 300 may determine to apply a constraint on a presence of the second SEI message in an SPO SEI message based on the first syntax elements (e.g., po_sei_wrapping_flag[i], po_sei_prefix_flag[i], etc.) and the second syntax elements (e.g., po_sei_wrapping_flag[j], po_sei_prefix_flag[j], etc.) (504). Determining to apply the constraint may include using at least one set of index values including a first value for the first index variable (e.g., index variable i) and a second value for the second index variable (e.g., index variable j), where the first value is different from the second value. In other words, the value of index variable i may equal the value of index variable j for some comparisons, and the value of index variable i may be different from the value of index variable j for some comparisons. In this manner, video decoder 300 can determine whether the constraint applies in situations where i j, rather than being limited to applying the constraint only in situations where i=j.

In some examples, video decoder 300 may determine that the first PO SEI wrapping flag (e.g., po_sei_wrapping_flag[i]) and the first PO SEI prefix flag (e.g., po_sei_prefix_flag[i]) are equal to zero and further determine to apply the constraint on the presence of the second SEI message in the SPO SEI message based on these determined values. In some examples, video decoder 300 may determine to apply the constraint when the following conditions are also met: (i) a first PO SEI payload type flag (e.g., po_sei_payload_type[i]) of the first SEI message is equal to a second PO SEI payload type flag (e.g., po_sei_payload_type[j]) of the second SEI message; (ii) the second PO SEI wrapping flag (e.g., po_sei_wrapping_flag[j]) is equal to zero; and the second PO SEI prefix flag (e.g., po_sei_prefix_flag[j]) is equal to one.

Applying the constraint may prevent the second SEI message from being present in the SPO SEI message. In some examples, the SPO SEI message may include the first SEI message. In other examples, the SPO SEI message may be in a same CLVS as a different SPO SEI message that includes the first SEI message.

Video decoder 300 may decode the second SEI message based on the constraint (506). For example, video decoder 300 may receive an encoded video bitstream and extract a sequence of NAL units. Video decoder 300 may examine a NAL unit header of each extracted NAL unit to identify non-VCL NAL units that include SEI messages based on a specific NAL unit type value. Upon identifying an SEI NAL unit, video decoder 300 may apply an emulation prevention removal process to an encapsulated payload of the SEI NAL unit.

The emulation prevention removal process may include detecting and removing emulation prevention bytes that were inserted during encoding to prevent accidental start code patterns, thereby recovering an original byte-aligned payload. Video decoder 300 may parse the original byte-aligned payload to determine a payload type and a payload size. Based on the payload type, video decoder 300 may identify a syntax structure of the second SEI message and extract corresponding syntax elements, including the second PO SEI wrapping flag and the second PO SEI prefix flag. Video decoder 300 may convert binary representations of the corresponding syntax elements back into semantic values.

By interpreting the semantic values in accordance with an established processing order and the constraint, video decoder 300 may determine how metadata within the second SEI message is applied to subsequent decoding, display, or post-processing operations for associated coded pictures. For example, in instances where video decoder 300 receives a non-conforming bitstream containing invalid message combinations that violate the applied constraint, video decoder 300 may execute an error handling operation. Upon detecting that the second SEI message violates the constraint based on the evaluation of the first index variable and the distinct second index variable, video decoder 300 may discard the non-conforming second SEI message to prevent processing sequence errors. Video decoder 300 may proceed to parse subsequent NAL units in the encoded video bitstream without applying the metadata of the discarded second SEI message to the associated coded pictures.

Examples of the various aspects of this disclosure may be used individually or in any combination. Additional aspects of the disclosure are detailed in numbered clauses below.

Clause 1A. An apparatus configured to decode video data, the apparatus comprising at least one memory, and processing circuitry in communication with the at least one memory, the processing circuitry configured to receive a first supplemental enhancement information (SEI) message related to the video data, wherein the first SEI message includes first syntax elements comprising a first processing order (PO) SEI wrapping flag and a first PO SEI prefix flag, wherein the first syntax elements are indexed by a first index variable, receive a second SEI message related to the video data, wherein the second SEI message includes second syntax elements comprising a second PO SEI wrapping flag and a second PO SEI prefix flag, wherein the second syntax elements are indexed by a second index variable distinct from the first index variable, determine to apply a constraint on a presence of the second SEI message in an SEI processing order (SPO) SEI message based on the first syntax elements and the second syntax elements, and decode the second SEI message based on the constraint.

Clause 2A. The apparatus of clause 1A, wherein to determine to apply the constraint on the presence of the second SEI message in the SPO SEI message, the processing circuitry is configured to determine to apply the constraint based on the first syntax elements and the second syntax elements using at least one set of index values including a first value for the first index variable and a second value for the second index variable, wherein the first value is different from the second value.

Clause 3A. The apparatus of any of clauses 1A and 2A, wherein to determine to apply the constraint on the presence of the second SEI message in the SPO SEI message, the processing circuitry is configured to determine that the first PO SEI wrapping flag and the first PO SEI prefix flag are equal to zero, and determine to apply the constraint on the presence of the second SEI message in the SPO SEI message based on the first PO SEI wrapping flag and the first PO SEI prefix flag being equal to zero.

Clause 4A. The apparatus of any of clauses 1A-3A, wherein to determine to apply the constraint on the presence of the second SEI message in the SPO SEI message, the processing circuitry is configured to determine that the first PO SEI wrapping flag and the first PO SEI prefix flag are equal to zero, determine that a first PO SEI payload type flag of the first SEI message is equal to a second PO SEI payload type flag of the second SEI message, determine that the second PO SEI wrapping flag is equal to zero, determine that the second PO SEI prefix flag is equal to one, and determine to apply the constraint on the presence of the second SEI message in the SPO SEI message based on the first PO SEI wrapping flag and the first PO SEI prefix flag being equal to zero, the first PO SEI payload type flag being equal to the second PO SEI payload type flag, the second PO SEI wrapping flag being equal to zero, and the second PO SEI prefix flag being equal to one.

Clause 5A. The apparatus of any of clauses 1A-4A, wherein the constraint prevents the second SEI message from being present in the SPO SEI message.

Clause 6A. The apparatus of any of clauses 1A-5A, wherein the SPO SEI message includes the first SEI message.

Clause 7A. The apparatus of any of clauses 1A-6A, wherein the SPO SEI message is in a same coded layer video sequence (CLVS) as a different SPO SEI message that includes the first SEI message.

Clause 8A. A method for decoding video data, the method comprising receiving, by processing circuitry, a first supplemental enhancement information (SEI) message related to the video data, wherein the first SEI message includes first syntax elements comprising a first processing order (PO) SEI wrapping flag and a first PO SEI prefix flag, wherein the first syntax elements are indexed by a first index variable, receiving, by the processing circuitry, a second SEI message related to the video data, wherein the second SEI message includes second syntax elements comprising a second PO SEI wrapping flag and a second PO SEI prefix flag, wherein the second syntax elements are indexed by a second index variable distinct from the first index variable, determining, by the processing circuitry, to apply a constraint on a presence of the second SEI message in an SEI processing order (SPO) SEI message based on the first syntax elements and the second syntax elements, and decoding, by the processing circuitry, the second SEI message based on the constraint.

Clause 9A. The method of clause 8A, wherein determining to apply the constraint on the presence of the second SEI message in the SPO SEI message comprises determining to apply the constraint based on the first syntax elements and the second syntax elements using at least one set of index values including a first value for the first index variable and a second value for the second index variable, wherein the first value is different from the second value.

Clause 10A. The method of any of clauses 8A and 9A, wherein determining to apply the constraint on the presence of the second SEI message in the SPO SEI message comprises determining that the first PO SEI wrapping flag and the first PO SEI prefix flag are equal to zero, and determining to apply the constraint on the presence of the second SEI message in the SPO SEI message based on the first PO SEI wrapping flag and the first PO SEI prefix flag being equal to zero.

Clause 11A. The method of any of clauses 8A-10A, wherein determining to apply the constraint on the presence of the second SEI message in the SPO SEI message comprises determining that the first PO SEI wrapping flag and the first PO SEI prefix flag are equal to zero, determining that a first PO SEI payload type flag of the first SEI message is equal to a second PO SEI payload type flag of the second SEI message, determining that the second PO SEI wrapping flag is equal to zero, determining that the second PO SEI prefix flag is equal to one, and determining to apply the constraint on the presence of the second SEI message in the SPO SEI message based on the first PO SEI wrapping flag and the first PO SEI prefix flag being equal to zero, the first PO SEI payload type flag being equal to the second PO SEI payload type flag, the second PO SEI wrapping flag being equal to zero, and the second PO SEI prefix flag being equal to one.

Clause 12A. The method of any of clauses 8A-11A, wherein the constraint prevents the second SEI message from being present in the SPO SEI message.

Clause 13A. The method of any of clauses 8A-12A, wherein the SPO SEI message includes the first SEI message.

Clause 14A. The method of any of clauses 8A-13A, wherein the SPO SEI message is in a same coded layer video sequence (CLVS) as a different SPO SEI message that includes the first SEI message.

Clause 15A. An apparatus configured to encode video data, the apparatus comprising at least one memory, and processing circuitry in communication with the at least one memory, the processing circuitry configured to generate a first supplemental enhancement information (SEI) message related to the video data, wherein the first SEI message includes first syntax elements comprising a first processing order (PO) SEI wrapping flag and a first PO SEI prefix flag, wherein the first syntax elements are indexed by a first index variable, generate a second SEI message related to the video data, wherein the second SEI message includes second syntax elements comprising a second PO SEI wrapping flag and a second PO SEI prefix flag, wherein the second syntax elements are indexed by a second index variable distinct from the first index variable, determine to apply a constraint on a presence of the second SEI message in an SEI processing order (SPO) SEI message based on the first syntax elements and the second syntax elements, and encode the second SEI message based on the constraint.

Clause 16A. The apparatus of clause 15A, wherein to determine to apply the constraint on the presence of the second SEI message in the SPO SEI message, the processing circuitry is configured to determine to apply the constraint based on the first syntax elements and the second syntax elements using at least one set of index values including a first value for the first index variable and a second value for the second index variable, wherein the first value is different from the second value.

Clause 17A. The apparatus of any of clauses 15A and 16A, wherein to determine to apply the constraint on the presence of the second SEI message in the SPO SEI message, the processing circuitry is configured to determine that the first PO SEI wrapping flag and the first PO SEI prefix flag are equal to zero, and determine to apply the constraint on the presence of the second SEI message in the SPO SEI message based on the first PO SEI wrapping flag and the first PO SEI prefix flag being equal to zero.

Clause 18A. The apparatus of any of clauses 15A-17A, wherein to determine to apply the constraint on the presence of the second SEI message in the SPO SEI message, the processing circuitry is configured to determine that the first PO SEI wrapping flag and the first PO SEI prefix flag are equal to zero, determine that a first PO SEI payload type flag of the first SEI message is equal to a second PO SEI payload type flag of the second SEI message, determine that the second PO SEI wrapping flag is equal to zero, determine that the second PO SEI prefix flag is equal to one, and determine to apply the constraint on the presence of the second SEI message in the SPO SEI message based on the first PO SEI wrapping flag and the first PO SEI prefix flag being equal to zero, the first PO SEI payload type flag being equal to the second PO SEI payload type flag, the second PO SEI wrapping flag being equal to zero, and the second PO SEI prefix flag being equal to one.

Clause 19A. The apparatus of any of clauses 15A-18A, wherein the constraint prevents the second SEI message from being present in the SPO SEI message.

Clause 20A. The apparatus of any of clauses 15A-19A, wherein the SPO SEI message includes the first SEI message or is in a same coded layer video sequence (CLVS) as a different SPO SEI message that includes the first SEI message.

Clause 1B. A method of processing video data, the method comprising: receiving, by processing circuitry, a supplemental enhancement information (SEI) message of a bitstream, the SEI message including one or more syntax elements; and controlling, by the processing circuitry, processing of one or more other SEI messages based on the one or more syntax elements.

Clause 2B. The method of clause 1B, wherein the SEI message is an SEI processing order (SPO) SEI message.

Clause 3B. The method of any of clauses 1B and 2B, wherein controlling, by the processing circuitry, the processing of the one or more other SEI messages based on the one or more syntax elements comprises applying, by the processing circuitry, a constraint on the processing of the one or more other SEI messages based on the one or more syntax elements.

Clause 4B. The method of any of clauses 1B-3B, wherein the one or more syntax elements indicate complexity information of one or more root processes.

Clause 5B. The method of any of clauses 1B-4B, wherein the one or more syntax elements indicate identical complexity information of one or more root processes and of a processing chain including the one or more root processes.

Clause 6B. The method of any of clauses 1B-5B, wherein controlling, by the processing circuitry, the processing of the one or more other SEI messages based on the one or more syntax elements comprises applying, by the processing circuitry, a constraint to not apply a processing chain when the SEI message is identified as a root process of the processing chain and a decoding system cannot interpret or does not support a message type of the SEI message.

Clause 7B. The method of any of clauses 1B-6B, wherein controlling, by the processing circuitry, the processing of the one or more other SEI messages based on the one or more syntax elements comprises applying, by the processing circuitry, a constraint to process different processing order nesting (PON)-nested SEI message types in a same order and for a decoder to operate on a single one PON-nested SEI message type of the different PON-nested SEI message types when the SEI message indicates that the different PON-nested SEI message types have a same payload type and an associated po_sei_prefix_flag equal to 0.

Clause 8B. The method of any of clauses 1B-7B, wherein controlling, by the processing circuitry, the processing of the one or more other SEI messages based on the one or more syntax elements comprises applying, by the processing circuitry, a constraint that when more than one PON SEI messages is present in an access unit, the value of pon_target_po_id[i] for any value of i in the range of 0 to pon_num_po_ids_minus1, inclusive, of a PON SEI message is not equal to the value pon_target_po_id[j] for any value of j in the range of 0 to pon_num_po_ids_minus1, inclusive, of a different PON SEI message, wherein i and j are integer values.

Clause 9B. The method of any of clauses 1B-8B, wherein controlling, by the processing circuitry, the processing of the one or more other SEI messages based on the one or more syntax elements comprises applying, by the processing circuitry, a constraint that when a PON-nested PON SEI message is specified in a PON SEI message, a value of pon_processing_order of the PON-nested SEI message with a same SEI message type is different in the PON SEI message.

Clause 10B. The method of any of clauses 1B-9B, wherein controlling, by the processing circuitry, the processing of the one or more other SEI messages based on the one or more syntax elements comprises applying, by the processing circuitry, a constraint that when any of the following conditions is true for any values of i and j in the range of 0 . . . pon_num_seis_minus1+1, i-th and j-th types of SEI messages indicated in a PON SEI message, where i-th SEI message is indicated in an SPO SEI message with associated syntax elements po_sei_payload_type[m], po_sei_prefix_flag[m] and po_sei_prefix_data_bit[m], and j-th SEI message is indicated in a different SPO SEI message with associated syntax elements po_sei_payload_type[n], po_sei_prefix_flag[n] and po_sei_prefix_data_bit[n], are considered different types of SEI messages:
po_sei_payload_type[m] is not equal to po_sei_payload_type[n]; po_sei_prefix_flag[m] is equal to 1, po_sei_prefix_flag[n] is equal to 1, and at least po_sei_prefix_data_bit[m][k] is not equal to po_sei_prefix_data_bit[n][k] for any value of k in the range of 0 . . . Min(po_num_bits_prefix_indication_minus1[m], po_num_bits_prefix_indication_minus1[n]); or po_sei_wrapping_flag[m] is equal to 1, po_sei_wrapping_flag[n] is equal to 1, and po_sei_processing_order[m] is not equal to po_sei_processing_order n],
   for each value of i in the range of 0 . . . pon_num_seis_minus1+1 and each value of j in the range of 0 . . . pon_num_seis_minus1+1 and not equal to i, the i-th and j-th types of SEI messages indicated in a PON SEI message are different from each other, wherein i and j are integer values.

Clause 11B. The method of any of clauses 1B-10B, wherein controlling, by the processing circuitry, the processing of the one or more other SEI messages based on the one or more syntax elements comprises applying, by the processing circuitry, a constraint that when a film grain characteristics SEI message is present with fg_characteristics_persistence_flag equal to 1 that is not a PON-nested SEI message, there is not an associated film grain characteristics SEI message in the same coded layer video sequence (CLVS) with fg_characteristics_cancel_flag equal to 1 that is a PON-nested SEI message.

Clause 12B. The method of any of clauses 1B-11B, wherein controlling, by the processing circuitry, the processing of the one or more other SEI messages based on the one or more syntax elements comprises applying, by the processing circuitry, a constraint that when a content color volume SEI message is present with ccv_persistence_flag equal to 1 that is not a PON-nested SEI message, there is not an associated content color volume SEI message in the same CLVS with ccv_cancel_flag equal to 1 that is a PON-nested SEI message.

Clause 13B. The method of any of clauses 1B-12B, wherein controlling, by the processing circuitry, the processing of the one or more other SEI messages based on the one or more syntax elements comprises applying, by the processing circuitry, a constraint that when an equirectangular projection SEI message is present with erp_persistence_flag equal to 1 that is not a PON-nested SEI message, there is not an associated equirectangular projection SEI message in the same CLVS with erp_cancel_flag equal to 1 that is a PON-nested SEI message.

Clause 14B. The method of any of clauses 1B-13B, wherein controlling, by the processing circuitry, the processing of the one or more other SEI messages based on the one or more syntax elements comprises applying, by the processing circuitry, a constraint that when a generalized cubemap projection SEI message is present with gcmp_persistence_flag equal to 1 that is not a PON-nested SEI message, there is not an associated generalized cubemap projection SEI message in the same CLVS with gcmp_cancel_flag equal to 1 that is a PON-nested SEI message.

Clause 15B. The method of any of clauses 1B-14B, wherein controlling, by the processing circuitry, the processing of the one or more other SEI messages based on the one or more syntax elements comprises applying, by the processing circuitry, a constraint that when a region-wise packing SEI message is present with rwp_persistence_flag equal to 1 that is not a PON-nested SEI message, there is not an associated region-wise packing SEI message in the same CLVS with rwp_cancel_flag equal to 1 that is a PON-nested SEI message.

Clause 16B. The method of any of clauses 1B-15B, wherein controlling, by the processing circuitry, the processing of the one or more other SEI messages based on the one or more syntax elements comprises applying, by the processing circuitry, a constraint that when a sample aspect ratio SEI message is present with sari_persistence_flag equal to 1 that is not a PON-nested SEI message, there is not an associated sample aspect ratio SEI message in the same CLVS with sari_cancel_flag equal to 1 that is a PON-nested SEI message.

Clause 17B. The method of any of clauses 1B-16B, wherein controlling, by the processing circuitry, the processing of the one or more other SEI messages based on the one or more syntax elements comprises applying, by the processing circuitry, a constraint that when an annotated regions SEI message is present that is not a PON-nested SEI message, there is not an associated annotated regions SEI message in the same CLVS with ar_cancel_flag equal to 1 that is a PON-nested SEI message.

Clause 18B. The method of any of clauses 1B-17B, wherein controlling, by the processing circuitry, the processing of the one or more other SEI messages based on the one or more syntax elements comprises applying, by the processing circuitry, a constraint that when an alpha channel information SEI message is present that is not a PON-nested SEI message, there is not an associated alpha channel information SEI message in the same CLVS with alpha_channel_cancel_flag equal to 1 that is a PON-nested SEI message.

Clause 19B. The method of any of clauses 1B-18B, wherein controlling, by the processing circuitry, the processing of the one or more other SEI messages based on the one or more syntax elements comprises applying, by the processing circuitry, a constraint that when a display orientation SEI message is present with display_orientation_persistence_flag equal to 1 that is not a PON-nested SEI message, there is not an associated display orientation SEI message in the same CLVS with display_orientation_cancel_flag equal to 1 that is a PON-nested SEI message.

Clause 20B. The method of any of clauses 1B-19B, wherein controlling, by the processing circuitry, the processing of the one or more other SEI messages based on the one or more syntax elements comprises applying, by the processing circuitry, a constraint that when an object mask information SEI message is present with omi_persistence_flag equal to 1 that is not a PON-nested SEI message, there is not an associated object mask information SEI message in the same CLVS with omi_cancel_flag equal to 1 that is a PON-nested SEI message.

Clause 21B. The method of any of clauses 1B-20B, wherein controlling, by the processing circuitry, the processing of the one or more other SEI messages based on the one or more syntax elements comprises applying, by the processing circuitry, a constraint that when a modality information SEI message is present with mi_modality_info_persistence_flag equal to 1 that is not a PON-nested SEI message, there is not an associated modality information SEI message in the same CLVS with mi_modality_info_cancel_flag equal to 1 that is a PON-nested SEI message.

Clause 22B. The method of any of clauses 1B-21B, wherein controlling, by the processing circuitry, the processing of the one or more other SEI messages based on the one or more syntax elements comprises applying, by the processing circuitry, a constraint that when an artificial intelligence (AI) usage restriction information SEI message is present with aur_persistence_flag equal to 1 that is not a PON-nested SEI message, there is not an associated AI usage restriction information SEI message in the same CLVS with aur_cancel_flag equal to 1 that is a PON-nested SEI message.

Clause 23B. The method of any of clauses 1B-22B, wherein the one or more syntax elements indicate a largest Versatile Supplemental Enhancement Information (VSEI) version number of the one or more SEI messages, and wherein controlling, by the processing circuitry, the processing of the one or more other SEI messages based on the one or more syntax elements comprises applying, by the processing circuitry, a constraint based on the largest VSEI version number of the one or more SEI messages.

Clause 24B. The method of any of clauses 1B-23B, wherein controlling, by the processing circuitry, the processing of the one or more other SEI messages based on the one or more syntax elements comprises: comparing, by the processing circuitry, po_sei_prefix_data_bit[i][j] syntax elements of the one or more other SEI messages; and differentiating the one or more other SEI messages from one another based on differing po_sei_prefix_data_bit[i][j] syntax elements of the one or more other SEI messages.

Clause 25B. The method of any of clauses 1B-24B, wherein the one or more other SEI messages are encapsulated within a processing order nesting (PON) SEI message, and wherein controlling, by the processing circuitry, the processing of the one or more other SEI messages based on the one or more syntax elements comprises differentiating the one or more other SEI messages from one another based on a pon_processing_order value of the PON SEI message.

Clause 26B. The method of any of clauses 1B-25B, wherein controlling, by the processing circuitry, the processing of the one or more other SEI messages based on the one or more syntax elements comprises applying, by the processing circuitry, a constraint that types of processing order nested (PON)-nested SEI messages indicated in a PON SEI message are different from one another.

Clause 27B. The method of any of clauses 1B-26B, wherein controlling, by the processing circuitry, the processing of the one or more other SEI messages based on the one or more syntax elements comprises applying, by the processing circuitry, a constraint that when a generalized cubemap projection SEI message is present with gcmp_persistence_flag equal to 1 that is not a PON-nested SEI message, there is not an associated generalized cubemap projection SEI message in the same CLVS that is a PON-nested SEI message.

Clause 28B. The method of any of clauses 1B-27B, wherein controlling, by the processing circuitry, the processing of the one or more other SEI messages based on the one or more syntax elements comprises applying, by the processing circuitry, a constraint that when an object mask information SEI message is present with omi_persistence_flag equal to 1 that is not a PON-nested SEI message, there is not an associated object mask information SEI message in the same CLVS that is a PON-nested SEI message.

Clause 29B. The method of any of clauses 1B-28B, wherein controlling, by the processing circuitry, the processing of the one or more other SEI messages based on the one or more syntax elements comprises applying, by the processing circuitry, a constraint that when a modality information SEI message is present with mi_modality_info_persistence_flag equal to 1 that is not a PON-nested SEI message, there is not an associated modality information SEI message in the same CLVS that is a PON-nested SEI message.

Clause 30B. The method of any of clauses 1B-29B, wherein controlling, by the processing circuitry, the processing of the one or more other SEI messages based on the one or more syntax elements comprises applying, by the processing circuitry, a constraint that when an AI usage restriction information SEI message is present with aur_persistence_flag equal to 1 that is not a PON-nested SEI message, there is not an associated AI usage restriction information SEI message in the same CLVS that is a PON-nested SEI message.

Clause 31B. The method of any of clauses 1B-30B, further comprising encoding the video data of the bitstream.

Clause 32B. A device for processing video data, the device comprising the processing circuitry configured to perform the method of any of clauses 1B-31B.

Clause 33B. The device of clause 32B, further comprising a display configured to display decoded video data.

Clause 34B. The device of any of clauses 32B and 33B, wherein the device comprises one or more of a camera, a computer, a mobile device, a broadcast receiver device, or a set-top box.

Clause 35B. The device of any of clauses 32B-34B, further comprising a memory configured to store the video data.

Clause 36B. A computer-readable storage medium having stored thereon instructions that, when executed, cause the processing circuitry to perform the method of any of clauses 1B-31B.

Clause 37B. A device for processing video data, the device comprising: means for receiving a supplemental enhancement information (SEI) message of a bitstream, the SEI message including one or more syntax elements; and means for controlling processing of one or more other SEI messages based on the one or more syntax elements.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured to decode video data, the apparatus comprising:
at least one memory; and
processing circuitry in communication with the at least one memory, the processing circuitry configured to:
receive a first supplemental enhancement information (SEI) message related to the video data, wherein the first SEI message includes first syntax elements comprising a first processing order (PO) SEI wrapping flag and a first PO SEI prefix flag, wherein the first syntax elements are indexed by a first index variable;
receive a second SEI message related to the video data, wherein the second SEI message includes second syntax elements comprising a second PO SEI wrapping flag and a second PO SEI prefix flag, wherein the second syntax elements are indexed by a second index variable distinct from the first index variable;
determine to apply a constraint on a presence of the second SEI message in an SEI processing order (SPO) SEI message based on the first syntax elements and the second syntax elements; and
decode the second SEI message based on the constraint.

2. The apparatus of claim 1, wherein to determine to apply the constraint on the presence of the second SEI message in the SPO SEI message, the processing circuitry is configured to determine to apply the constraint based on the first syntax elements and the second syntax elements using at least one set of index values including a first value for the first index variable and a second value for the second index variable, wherein the first value is different from the second value.

3. The apparatus of claim 1, wherein to determine to apply the constraint on the presence of the second SEI message in the SPO SEI message, the processing circuitry is configured to:
determine that the first PO SEI wrapping flag and the first PO SEI prefix flag are equal to zero; and
determine to apply the constraint on the presence of the second SEI message in the SPO SEI message based on the first PO SEI wrapping flag and the first PO SEI prefix flag being equal to zero.

4. The apparatus of claim 1, wherein to determine to apply the constraint on the presence of the second SEI message in the SPO SEI message, the processing circuitry is configured to:
determine that the first PO SEI wrapping flag and the first PO SEI prefix flag are equal to zero;
determine that a first PO SEI payload type flag of the first SEI message is equal to a second PO SEI payload type flag of the second SEI message;
determine that the second PO SEI wrapping flag is equal to zero;
determine that the second PO SEI prefix flag is equal to one; and
determine to apply the constraint on the presence of the second SEI message in the SPO SEI message based on the first PO SEI wrapping flag and the first PO SEI prefix flag being equal to zero, the first PO SEI payload type flag being equal to the second PO SEI payload type flag, the second PO SEI wrapping flag being equal to zero, and the second PO SEI prefix flag being equal to one.

5. The apparatus of claim 1, wherein the constraint prevents the second SEI message from being present in the SPO SEI message.

6. The apparatus of claim 1, wherein the SPO SEI message includes the first SEI message.

7. The apparatus of claim 1, wherein the SPO SEI message is in a same coded layer video sequence (CLVS) as a different SPO SEI message that includes the first SEI message.

8. A method for decoding video data, the method comprising:
receiving, by processing circuitry, a first supplemental enhancement information (SEI) message related to the video data, wherein the first SEI message includes first syntax elements comprising a first processing order (PO) SEI wrapping flag and a first PO SEI prefix flag, wherein the first syntax elements are indexed by a first index variable;
receiving, by the processing circuitry, a second SEI message related to the video data, wherein the second SEI message includes second syntax elements comprising a second PO SEI wrapping flag and a second PO SEI prefix flag, wherein the second syntax elements are indexed by a second index variable distinct from the first index variable;
determining, by the processing circuitry, to apply a constraint on a presence of the second SEI message in an SEI processing order (SPO) SEI message based on the first syntax elements and the second syntax elements; and
decoding, by the processing circuitry, the second SEI message based on the constraint.

9. The method of claim 8, wherein determining to apply the constraint on the presence of the second SEI message in the SPO SEI message comprises determining to apply the constraint based on the first syntax elements and the second syntax elements using at least one set of index values including a first value for the first index variable and a second value for the second index variable, wherein the first value is different from the second value.

10. The method of claim 8, wherein determining to apply the constraint on the presence of the second SEI message in the SPO SEI message comprises:
determining that the first PO SEI wrapping flag and the first PO SEI prefix flag are equal to zero; and
determining to apply the constraint on the presence of the second SEI message in the SPO SEI message based on the first PO SEI wrapping flag and the first PO SEI prefix flag being equal to zero.

11. The method of claim 8, wherein determining to apply the constraint on the presence of the second SEI message in the SPO SEI message comprises:
determining that the first PO SEI wrapping flag and the first PO SEI prefix flag are equal to zero;
determining that a first PO SEI payload type flag of the first SEI message is equal to a second PO SEI payload type flag of the second SEI message;
determining that the second PO SEI wrapping flag is equal to zero;
determining that the second PO SEI prefix flag is equal to one; and
determining to apply the constraint on the presence of the second SEI message in the SPO SEI message based on the first PO SEI wrapping flag and the first PO SEI prefix flag being equal to zero, the first PO SEI payload type flag being equal to the second PO SEI payload type flag, the second PO SEI wrapping flag being equal to zero, and the second PO SEI prefix flag being equal to one.

12. The method of claim 8, wherein the constraint prevents the second SEI message from being present in the SPO SEI message.

13. The method of claim 8, wherein the SPO SEI message includes the first SEI message.

14. The method of claim 8, wherein the SPO SEI message is in a same coded layer video sequence (CLVS) as a different SPO SEI message that includes the first SEI message.

15. An apparatus configured to encode video data, the apparatus comprising:
at least one memory; and
processing circuitry in communication with the at least one memory, the processing circuitry configured to:
generate a first supplemental enhancement information (SEI) message related to the video data, wherein the first SEI message includes first syntax elements comprising a first processing order (PO) SEI wrapping flag and a first PO SEI prefix flag, wherein the first syntax elements are indexed by a first index variable;
generate a second SEI message related to the video data, wherein the second SEI message includes second syntax elements comprising a second PO SEI wrapping flag and a second PO SEI prefix flag, wherein the second syntax elements are indexed by a second index variable distinct from the first index variable;
determine to apply a constraint on a presence of the second SEI message in an SEI processing order (SPO) SEI message based on the first syntax elements and the second syntax elements; and
encode the second SEI message based on the constraint.

16. The apparatus of claim 15, wherein to determine to apply the constraint on the presence of the second SEI message in the SPO SEI message, the processing circuitry is configured to determine to apply the constraint based on the first syntax elements and the second syntax elements using at least one set of index values including a first value for the first index variable and a second value for the second index variable, wherein the first value is different from the second value.

17. The apparatus of claim 15, wherein to determine to apply the constraint on the presence of the second SEI message in the SPO SEI message, the processing circuitry is configured to:
determine that the first PO SEI wrapping flag and the first PO SEI prefix flag are equal to zero; and
determine to apply the constraint on the presence of the second SEI message in the SPO SEI message based on the first PO SEI wrapping flag and the first PO SEI prefix flag being equal to zero.

18. The apparatus of claim 15, wherein to determine to apply the constraint on the presence of the second SEI message in the SPO SEI message, the processing circuitry is configured to:
determine that the first PO SEI wrapping flag and the first PO SEI prefix flag are equal to zero;
determine that a first PO SEI payload type flag of the first SEI message is equal to a second PO SEI payload type flag of the second SEI message;
determine that the second PO SEI wrapping flag is equal to zero;
determine that the second PO SEI prefix flag is equal to one; and
determine to apply the constraint on the presence of the second SEI message in the SPO SEI message based on the first PO SEI wrapping flag and the first PO SEI prefix flag being equal to zero, the first PO SEI payload type flag being equal to the second PO SEI payload type flag, the second PO SEI wrapping flag being equal to zero, and the second PO SEI prefix flag being equal to one.

19. The apparatus of claim 15, wherein the constraint prevents the second SEI message from being present in the SPO SEI message.

20. The apparatus of claim 15, wherein the SPO SEI message includes the first SEI message or is in a same coded layer video sequence (CLVS) as a different SPO SEI message that includes the first SEI message.
